(19) United States
(12) Patent Application Publication
(10) Pub. No.: US 2026/0349581 A1
(43) Pub. Date: Nov. 5, 2026

(54) ELECTRONIC DEVICE, METHOD, AND NON-TRANSITORY COMPUTER READABLE STORAGE MEDIUM TO DISPLAY INFORMATION ON WIDGET

(71) Applicant: Samsung Electronics Co., Ltd., Suwon-si (KR)

(72) Inventors: Jinkyo CHUNG, Suwon-si (KR); Ilku CHANG, Suwon-si (KR); Minji LEE, Suwon-si (KR); Jihyun BANG, Suwon-si (KR)

(21) Appl. No.: 19/536,852

(22) Filed: Feb. 11, 2026

Related U.S. Application Data
(63) Continuation of application No. PCT/KR2026/001221, filed on Jan. 21, 2026.

(30) Foreign Application Priority Data
Apr. 30, 2025 (KR) 10-2025-0057836
Jun. 17, 2025 (KR) 10-2025-0079901
Jul. 25, 2025 (KR) 10-2025-0101136

(51) Int. Cl. G06F 3/0482

(52) U.S. Cl. CPC G06F 3/0482

(57) ABSTRACT

An electronic device includes memory storing instructions, a display, and at least one processor. The instructions cause the electronic device to display, via the display, a screen including a widget corresponding to a software application, identify whether a condition for suggesting executing a preset function provided through the software application is satisfied while the widget is included in the screen, and display a screen including a stacked element, which is displayed superimposed on the widget and suggests executing the preset function based on determination that the condition is satisfied.

### CROSS-REFERENCE TO RELATED APPLICATION(S)

This application is a continuation application, claiming priority under 35 U.S.C. § 365(c), of an International application No. PCT/KR2026/001221, filed on Jan. 21, 2026, which is based on and claims the benefit of a Korean patent application number 10-2025-0057836, filed on Apr. 30, 2025, in the Ministry of Intellectual Property, of a Korean patent application number 10-2025-0079901, filed on Jun. 17, 2025, in the Ministry of Intellectual Property, and of a Korean patent application number 10-2025-0101136, filed on Jul. 25, 2025, in the Ministry of Intellectual Property, the disclosure of each of which is incorporated by reference herein in its entirety.

### TECHNICAL FIELD

The disclosure relates to an electronic device, a method, and a non-transitory computer readable storage medium for displaying information on a widget.

### BACKGROUND ART

An electronic device may include a display. The electronic device may display a widget that provides a feature through a display. The widget may be included in a home screen and/or a lock screen. The electronic device may provide a feature corresponding to the widget based on a user input received for the widget.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an electronic device, a method, and a non-transitory computer readable storage medium for displaying information on a widget.

Additional aspects will be set forth in part in the description which follows and, in part, will be apparent from the description, or may be learned by practice of the presented embodiments.

In accordance with an aspect of the disclosure, an electronic device is provided. The electronic device may include a display. The electronic device may include memory including one or more storage media storing instructions. The electronic device may include at least one processor including processing circuitry. The instructions, when executed by the at least one processor individually or collectively, may cause the electronic device to display, via the display, a screen including a widget corresponding to a software application. The instructions, when executed by the at least one processor individually or collectively, may cause the electronic device to identify whether a condition for suggesting execution of a preset function provided through the software application is satisfied while the widget is included in the screen. The instructions, when executed by the at least one processor individually or collectively, may cause the electronic device to display, via the display, the screen including a stacked element, which is displayed superimposed on the widget and suggests execution of the preset function, based on determination that the condition is satisfied.

In accordance with another aspect of the disclosure, a method is provided. The method may be executed in an electronic device with a display. The method may include displaying, via the display, a screen including a widget corresponding to a software application. The method may include identifying whether a condition for suggesting execution of a preset function provided through the software application is satisfied while the widget is included in the screen. The method may include displaying, via the display, the screen including a stacked element, which is displayed superimposed on the widget and suggests execution of the preset function, based on determination that the condition is satisfied.

In accordance with another aspect of the disclosure, a non-transitory computer readable storage medium is provided. The non-transitory computer readable storage medium may store one or more programs. The one or more programs may include, when executed by an electronic device with a display, instructions causing the electronic device to display, via the display, a screen including a widget corresponding to a software application. The one or more programs may include, when executed by the electronic device, instructions causing the electronic device to identify whether a condition for suggesting execution of a preset function provided through the software application is satisfied while the widget is included in the screen. The one or more programs may include, when executed by the electronic device, instructions causing the electronic device to display, via the display, the screen including a stacked element, which is displayed superimposed on the widget and suggests execution of the preset function, based on determination that the condition is satisfied.

In accordance with another aspect of the disclosure, an electronic device is described. The electronic device may include a display. The electronic device may include memory including one or more storage media storing instructions. The electronic device may include at least one processor including processing circuitry. The instructions, when executed by the at least one processor individually or collectively, may cause the electronic device to identify whether a condition for generating a widget providing a defined feature is satisfied. The instructions, when executed by the at least one processor individually or collectively, may cause the electronic device to display a bar-shaped widget on a home screen indicating that the condition is satisfied, based on determination that the condition is satisfied. The instructions, when executed by the at least one processor individually or collectively, may cause the electronic device to display, via the display, a pop-up window suggesting generation of the widget, based on receiving a first user input for the bar-shaped widget. The instructions, when executed by the at least one processor individually or collectively, may cause the electronic device to display the widget providing the defined feature on the home screen, based on receiving a second user input for the pop-up window.

In accordance with another aspect of the disclosure, a method is provided. The method may be executed in an electronic device with a display. The method may include identifying whether a condition for generating a widget providing a defined feature is satisfied. The method may include displaying a bar-shaped widget on a home screen indicating that the condition is satisfied, based on determination that the condition is satisfied. The method may include displaying, via the display, a pop-up window suggesting generation of the widget, based on receiving a first user input for the bar-shaped widget. The method may include displaying the widget providing the defined feature on the home screen, based on receiving a second user input for the pop-up window.

In accordance with another aspect of the disclosure, a non-transitory computer readable storage medium is provided. The non-transitory computer readable storage medium may store one or more programs. The one or more programs may include, when executed by an electronic device with a display, instructions causing the electronic device to identify whether a condition for generating a widget providing a defined feature is satisfied. The one or more programs may include, when executed by the electronic device, instructions causing the electronic device to display a bar-shaped widget on a home screen indicating that the condition is satisfied, based on determination that the condition is satisfied. The one or more programs may include, when executed by the electronic device, instructions causing the electronic device to display, via the display, a pop-up window suggesting generation of the widget, based on receiving a first user input for the bar-shaped widget. The one or more programs may include, when executed by the electronic device, instructions causing the electronic device to display the widget providing the defined feature on the home screen, based on receiving a second user input for the pop-up window.

In accordance with another aspect of the disclosure, an electronic device is described. The electronic device may include a display. The electronic device may include memory including one or more storage media storing instructions. The electronic device may include at least one processor including processing circuitry. The instructions, when executed by the at least one processor individually or collectively, may cause the electronic device to display, via the display, a screen including a widget corresponding to a software application. The instructions, when executed by the at least one processor individually or collectively, may cause the electronic device to identify at least one executable action in relation with the software application. The instructions, when executed by the at least one processor individually or collectively, may cause the electronic device to display, via the display, a stacked element at least partially superimposed on the widget to suggest the at least one executable action.

In accordance with another aspect of the disclosure, a method is provided. The method may be executed in an electronic device with a display. The method may include displaying, via the display, a screen including a widget corresponding to a software application. The method may include identifying at least one executable action in relation with the software application. The method may include displaying, via the display, a stacked element at least partially superimposed on the widget to suggest the at least one executable action.

In accordance with another aspect of the disclosure, a non-transitory computer readable storage medium is provided. The non-transitory computer readable storage medium may store one or more programs. The one or more programs may include, when executed by an electronic device with a display, instructions causing the electronic device to display, via the display, a screen including a widget corresponding to a software application. The one or more programs may include, when executed by the electronic device, instructions causing the electronic device to identify at least one executable action in relation with the software application. The one or more programs may include, when executed by the electronic device, instructions causing the electronic device to display, via the display, a stacked element at least partially superimposed on the widget to suggest the at least one executable action.

In accordance with another aspect of the disclosure, an electronic device is provided. The electronic device may include a display. The electronic device may include memory including one or more storage media storing instructions. The electronic device may include at least one processor including processing circuitry. The instructions, when executed by the at least one processor individually or collectively, may cause the electronic device to identify at least one executable action in relation with a software application. The instructions, when executed by the at least one processor individually or collectively, may cause the electronic device to, based at least in part on the identification, display, via the display, a graphical object indicating the at least one executable action on a home screen. The instructions, when executed by the at least one processor individually or collectively, may cause the electronic device to receive, via the display, a first user input with respect to the graphical object. The instructions, when executed by the at least one processor individually or collectively, may cause the electronic device to display, via the display, a pop-up window to generate a widget corresponding to the at least one executable action. The instructions, when executed by the at least one processor individually or collectively, may cause the electronic device to receive, via the display, a second user input with respect to the pop-up window. The instructions, when executed by the at least one processor individually or collectively, may cause the electronic device to display, via the display, the widget on the home screen.

In accordance with another aspect of the disclosure, a method is provided. The method may be executed in an electronic device with a display. The method may include identifying at least one executable action in relation with a software application. The method may include, based at least in part on the identification, displaying, via the display, a graphical object indicating the at least one executable action on a home screen. The method may include receiving, via the display, a first user input with respect to the graphical object. The method may include displaying, via the display, a pop-up window to generate a widget corresponding to the at least one executable action. The method may include receiving, via the display, a second user input with respect to the pop-up window. The method may include displaying, via the display, the widget on the home screen.

In accordance with another aspect of the disclosure, a non-transitory computer readable storage medium is provided. The non-transitory computer readable storage medium may store one or more programs. The one or more programs may include, when executed by an electronic device with a display, instructions causing the electronic device to identify at least one executable action in relation with a software application. The one or more programs may include, when executed by the electronic device, instructions causing the electronic device to display, based at least in part on the identification, via the display, a graphical object indicating the at least one executable action on a home screen. The one or more programs may include, when executed by the electronic device, instructions causing the electronic device to receive, via the display, a first user input with respect to the graphical object. The one or more programs may include, when executed by the electronic device, instructions causing the electronic device to display, via the display, a pop-up window to generate a widget corresponding to the at least one executable action. The one or more programs may include, when executed by the electronic device, instructions causing the electronic device to receive, via the display, a second user input with respect to the pop-up window. The one or more programs may include, when executed by the electronic device, instructions causing the electronic device to display, via the display, the widget on the home screen.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an electronic device displaying a widget according to an embodiment of the disclosure;

FIG. 2 is a simplified block diagram of an electronic device according to an embodiment of the disclosure;

FIG. 3 is a flowchart indicating an operation of an electronic device that displays a stacked element superimposed on a widget according to an embodiment of the disclosure;

FIG. 4 illustrates an operation of an electronic device that changes a state of a widget based on a user input according to an embodiment of the disclosure;

FIG. 5 illustrates an operation of an electronic device that changes a state of a widget according to a satisfied condition according to an embodiment of the disclosure;

FIG. 6 illustrates an operation of an electronic device that displays stacked elements according to an embodiment of the disclosure;

FIGS. 7 and 8 illustrate operations of an electronic device that changes a state of a user interface (UI) object based on a size of a widget according to various embodiments of the disclosure;

FIG. 9 illustrates an operation of an electronic device that ceases displaying a stacked element based on a user input according to an embodiment of the disclosure;

FIG. 10 illustrates an operation of an electronic device that controls a function based on a user input with respect to a UI object according to an embodiment of the disclosure;

FIG. 11 illustrates an operation of an electronic device that displays a stacked element according to an embodiment of the disclosure;

FIG. 12 illustrates an area in which a widget may be displayed, according to an embodiment of the disclosure;

FIG. 13 illustrates an operation of an electronic device that displays a stacked element when a plurality of software applications are executed according to an embodiment of the disclosure;

FIG. 14 illustrates an operation of an electronic device that provides a function based on a user input with respect to a widget in a lock screen according to an embodiment of the disclosure;

FIG. 15 illustrates an operation of an electronic device that displays a graphical object indicating that a feature is provided on a recent apps screen according to an embodiment of the disclosure;

FIG. 16 illustrates an operation of an electronic device that displays a graphical object indicating that a feature is provided on a notification window according to an embodiment of the disclosure;

FIG. 17 is a flowchart indicating an operation of an electronic device that displays a pop-up window suggesting generation of a widget according to an embodiment of the disclosure;

FIG. 18 illustrates an operation of an electronic device that displays a pop-up window based on a user input received for a bar-shaped widget according to an embodiment of the disclosure;

FIG. 19 illustrates an operation of an electronic device that displays a pop-up window when a software application is executed according to an embodiment of the disclosure;

FIG. 20 illustrates a pop-up window according to an embodiment of the disclosure;

FIG. 21 illustrates an operation of a foldable electronic device displaying a stacked element according to an embodiment of the disclosure;

FIG. 22 illustrates an operation of a foldable electronic device displaying an additional stacked element according to an embodiment of the disclosure;

FIG. 23 is a block diagram of an electronic device in a network environment according to various embodiments

FIG. 24 is a schematic diagram of an exemplary AI system.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

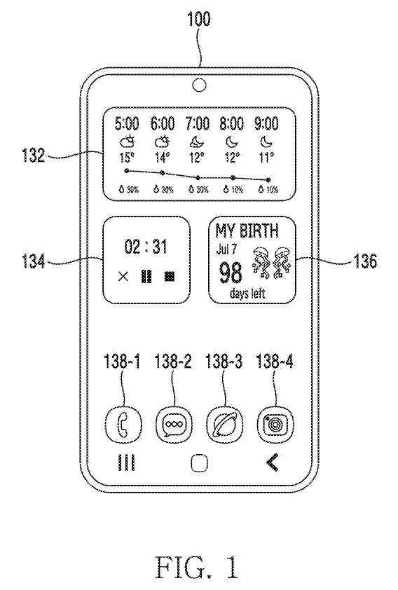

FIG. 1 illustrates an electronic device displaying a widget according to an embodiment of the disclosure.

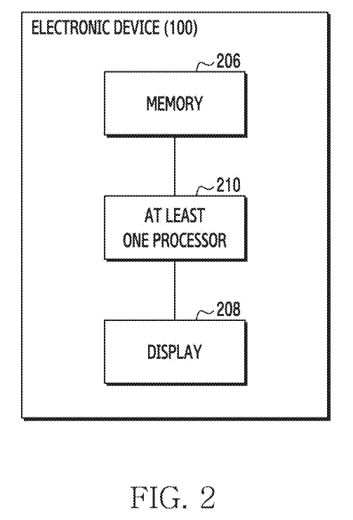

Referring to FIG. 1, an electronic device 100 may include a display (e.g., a display 208 of FIG. 2). The electronic device 100 may be used to provide various functions to a user of the electronic device 100. For example, at least some of the various functions may be provided based on widgets 132, 134, and 136 displayed via the display. For example, the widget 132 may be provided through a software application for weather. For example, the widget 134 may be provided through a software application for recording. For example, the widget 136 may be provided through a software application for a schedule.

The widgets 132, 134, and 136 displayed via the display may be included in a home screen. For example, the electronic device 100 may display the home screen including the widgets 132, 134, and 136 via the display. For example, the home screen may include an icon corresponding to a software application. For example, the home screen may include an icon 138-1 corresponding to a software application for a call. For example, the home screen may include an icon 138-2 corresponding to a software application for a message. For example, the home screen may include an icon 138-3 corresponding to a software application for web browsing. For example, the home screen may include an icon 138-4 corresponding to a software application for a camera. The home screen including the widgets 132, 134, and 136 and the icons 138-1, 138-2, 138-3, and 138-4 has been described, but an embodiment of the disclosure is not limited thereto. For example, the widgets and the icons may be included in a screen (e.g., a lock screen, a cover screen, and the like) different from the home screen.

As the user of the electronic device 100 provides a user input to the electronic device 100, the user may use a function (or a feature) provided through the electronic device 100. For example, the user may handle a productive task by using a useful function on their own. For example, various functions provided through the electronic device 100 may be helpful to the user. ‎Since the functions provided through the electronic device 100 are so diverse, the user may recognize only some of the functions that are helpful to the user themself. For example, since the user does not know whether a specified function provided through the electronic device 100 is useful for a task, the user may not input a user input for executing the specified function to the electronic device 100. For example, the electronic device 100 may be required to provide the user with a specified function at an appropriate timing. For example, the electronic device 100 may be required to suggest the user to use a specified function.

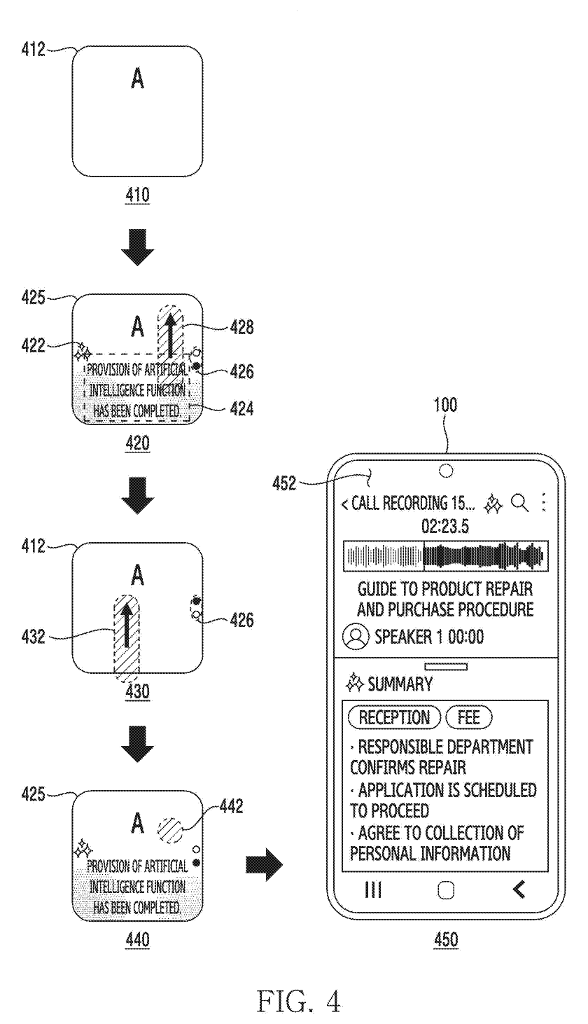

For example, the electronic device 100 may identify whether a second function in relation with a widget (e.g., the widget 134) may be provided by using first information included in a screen and obtained through the widget to provide a first function. For example, the electronic device 100 may determine that the second function is available based on obtaining the first information as a result of providing the first function. For example, based on the determination that the second function is available, the electronic device 100 may obtain second information as a result of providing the second function by providing or executing the second function. For example, based on obtaining the second information, the electronic device 100 may display a stacked element (e.g., a stacked element 425 of FIG. 4) indicating that the second information is obtained, superimposed on the widget.

For example, the electronic device 100 may include hardware components used to perform or execute the operations. The hardware components are described and exemplified with reference to FIG. 2.

FIG. 2 is a simplified block diagram of an electronic device according to an embodiment of the disclosure.

Referring to FIG. 2, an electronic device 100 may include a display 208, at least one processor 210, and memory 206.

The at least one processor 210 may include a hardware component for processing data using instructions stored in the memory 206. The hardware component for processing data may include a central processing unit (CPU) (e.g., including processing circuitry). The hardware component for processing data may include a graphics processing unit (GPU) (e.g., including processing circuitry). The hardware component for processing data may include a display processing unit (DPU) (e.g., including processing circuitry). The hardware component for processing data may include a neural processing unit (NPU) (e.g., including processing circuitry).

The at least one processor 210 may include one or more cores. For example, the at least one processor 210 may have a structure of a multi-core processor, such as a dual core, a quad core, or a hexa core.

The memory 206 may include a hardware component for storing data and/or instructions inputted to the at least one processor 210 and/or outputted from the at least one processor 210. The memory 206 may include, for example, volatile memory, such as random-access memory (RAM) and/or non-volatile memory, such as read-only memory (ROM). The volatile memory may include, for example, at least one of dynamic RAM (DRAM), static RAM (SRAM), cache RAM, and pseudo SRAM (PSRAM). The non-volatile memory may include at least one of, for example, programmable ROM (PROM), erasable PROM (EPROM), electrically erasable PROM (EEPROM), flash memory, hard disk, compact disc, and embedded multimedia card (EMMC).

The display 208 may output visualized information. For example, the display 208 may output visualized information to the user under control of the at least one processor 210. The display 208 may include a hardware component of the electronic device 100 used to display a screen. For example, the display 208 may include light-emitting elements and circuits (e.g., transistors) that control the light-emitting elements to emit light. For example, each of the light-emitting elements may include an organic light emitting diode (OLED) or a micro LED. However, it is not limited thereto. For example, the display 208 may include a liquid crystal display (LCD).

The at least one processor 210 may display a screen (e.g., a lock screen, a cover screen, a home screen, and the like) including a widget (e.g., a widget 412 of FIG. 4) for providing a first function, via the display 208. While the widget is included in the screen, the at least one processor 210 may obtain first information indicating a result of providing the first function by providing the first function. For example, the at least one processor 210 may obtain second information indicating a result of providing a second function by providing the second function linked with the first function using the first information based on obtaining the first information. Based on obtaining the second information, the at least one processor 210 may display, via the display 208, the screen including a stacked element (e.g., the stacked element 425 of FIG. 4) displayed superimposed on the widget.

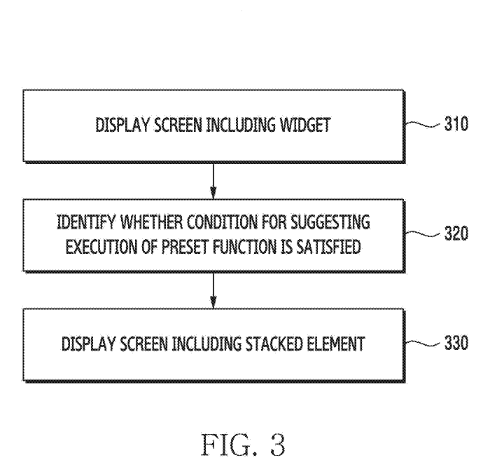

FIG. 3 is a flowchart indicating an operation of an electronic device that displays a stacked element superimposed on a widget according to an embodiment of the disclosure.

This method may be executed by an electronic device 100 illustrated in FIG. 2 or at least one processor 210 of the electronic device 100. In the following embodiment of the disclosure, each operation may also be sequentially performed, but is not necessarily performed sequentially. For example, an order of each operation may also be changed, and at least two operations may also be performed in parallel.

Referring to FIG. 3, in operation 310, the at least one processor 210 may display a screen including a widget (e.g., a widget 412 of FIG. 4) corresponding to a software application via a display 208. For example, the software application may be used to execute a specified function (e.g., a first function to be described later). For example, the at least one processor 210 may display a screen (e.g., a lock screen, a cover screen, or a home screen) including a widget (e.g., the widget 412 of FIG. 4) to provide the first function via the display 208. For example, the widget included in the screen may be located in the screen by a user of the electronic device 100. For example, the widget may include a widget based on a software application for recording audio. For example, the widget may include a widget based on a software application that provides weather information. For example, the widget may include a software application for managing health (e.g., the number of steps, an amount of exercise, a sleep score, and the like) of the user of the electronic device 100. For example, the widget may include a software application for digital well-being (e.g., a limit of a time during which a display is turned on or a time during which a specified software application is executed). For example, the widget may include a software application indicating a calendar or a schedule. For example, the widget may include a software application for translation. For example, the widget may include a software application for a web browser. However, an embodiment of the disclosure is not limited thereto.

In operation 320, the at least one processor 210 may identify whether a condition for suggesting execution of a preset function (e.g., a second function to be described later) (or a preset action) provided through a software application is satisfied while a widget (e.g., the widget 412 of FIG. 4) is included in a screen (e.g., a lock screen, a cover screen, a home screen, and the like). For example, the condition may be described as a condition for suggesting the user of the electronic device 100 to execute a preset function (e.g., a function provided through an artificial intelligence model). For example, the condition may include determination that the preset function is available.

While the widget is included in the screen, the at least one processor 210 may obtain first information indicating a result of providing the first function by providing the first function. For example, the first information may be described as information obtained as the first function is provided through the electronic device 100. For example, the first information may include recorded audio data. For example, the first information may include periodically updated weather information. For example, the first information may include information indicating a health status (e.g., the number of steps, a sleep score, and the like) of the user of the electronic device 100. For example, the first information may include information indicating a time when a specified software application is executed. For example, the first information may include information indicating a birthday of a specified person. For example, the first information may include information indicating that the user of the electronic device 100 is scheduled to visit a specified country. For example, the first information may include information indicating a keyword included in the news. However, an embodiment of the disclosure is not limited thereto.

The at least one processor 210 may obtain second information indicating a result of providing a second function by providing the second function linked with the first function using the first information based on obtaining the first information. For example, the second function may be described as a function provided (or executed) by using the first information obtained through the first function among a plurality of functions provided through a software application corresponding to the first function. For example, the second function may be described as a function to provide the user with useful information by providing the first information to the artificial intelligence model (or a pre-trained model).

As a non-limiting example, the at least one processor 210 may identify whether the second function is executable before executing the second function. For example, before executing the second function, the at least one processor 210 may identify whether the second function is available. For example, the at least one processor 210 may identify the second function as executable or available based on determination that the first information is obtained by providing the first function. For example, the at least one processor 210 may obtain the second information by providing the second function based on determination that the second function is executable or available. For example, the at least one processor 210 may determine that a defined condition for executing the second function is satisfied based on the determination that the first information is obtained. For example, the at least one processor 210 may obtain the second information indicating a result of the second function by providing or executing the second function based on the determination that the defined condition is satisfied.

In operation 330, the at least one processor 210 may display, via the display 208, the screen including a stacked element (e.g., a stacked element 425 of FIG. 4) that is displayed superimposed on a widget (e.g., the widget 412 of FIG. 4) based on the determination that the condition is satisfied and suggests execution of the preset function. For example, the stacked element may be used to suggest the execution of the preset function. For example, the stacked element may be displayed at least partially superimposed on the widget.

Based on obtaining the second information, the at least one processor 210 may display, via the display 208, the screen including a stacked element (e.g., the stacked element 425 of FIG. 4) displayed superimposed on the widget. For example, the stacked element may indicate that the second information is obtained. For example, the stacked element may be displayed on an area of the screen where the widget is located. For example, the stacked element may be displayed superimposed on the widget included on the screen. For example, the stacked element displayed superimposed on the widget will be described later with reference to FIG. 4.

The at least one processor 210 may provide the user with useful information by displaying the stacked element superimposed on the widget. For example, the user may recognize that the second function is provided through the stacked element. For example, the user may recognize information helpful to the user without a user input caused by the user through the stacked element. For example, the stacked element may be used to suggest to the user a continuous use of the second function. For example, since the user recognizes the stacked element, the user may input a user input to execute a new function (e.g., the second function) that the user has not recognized to improve efficiency of a task, to the electronic device 100.

As a non-limiting example, the at least one processor 210 may identify whether a condition for displaying the stacked element is satisfied after displaying the stacked element. For example, after displaying the stacked element, the at least one processor 210 may cease or refrain from displaying the stacked element based on determination that the condition for displaying the stacked element is not satisfied.

As a non-limiting example, the at least one processor 210 may display a timer indicating the time interval together with the stacked element based on determination that the condition for displaying the stacked element is satisfied for a specified time interval. For example, as the user recognizes the timer, the user may provide an input with respect to the stacked element.

FIG. 4 illustrates an operation of an electronic device that changes a state of a widget based on a user input according to an embodiment of the disclosure.

Referring to FIG. 4, a state 410 may be described as a state in which a widget 412 is displayed via a display 208. For example, at least one processor 210 may display a screen (e.g., a lock screen, a cover screen, a home screen, and the like) including the widget 412, via the display 208.

A state 420 may be described as a state in which a stacked element 425 is displayed via the display 208. For example, as providing the second function, at least one processor 210 may obtain the second information indicating a result of providing the second function. For example, based on obtaining the second information, the at least one processor 210 may display the stacked element 425 superimposed on the widget 412. For example, the at least one processor 210 may display the stacked element 425 superimposed on the widget 412 based on the second information obtained while the widget 412 is included in the screen.

As a non-limiting example, the stacked element 425 may indicate that the second information is obtained. For example, the stacked element 425 may include a graphical object 422 representing that the second information is obtained through an artificial intelligence model. For example, the stacked element 425 may include a visual indication 426 indicating that the widget 412 is located (or disposed) under the stacked element 425. For example, the stacked element 425 may include a text 424. For example, the text 424 may indicate that the provision of the second function is completed. However, an embodiment of the disclosure is not limited thereto. For example, the text 424 may indicate at least a portion of the second information.

For example, the user may recognize that the second function (or the second information) corresponding to the stacked element 425 is provided through the artificial intelligence model (or pre-trained model) through the graphical object 422. For example, the user may recognize that the stacked element 425 is displayed at least partially superimposed on the widget 412 through the visual indication 426. For example, the user may recognize that the second information is obtained according to the second function through the text 424.

As a non-limiting example, a technique (or a scheme) of displaying the stacked element 425 superimposed on the widget 412 may be referred to as a carousel technique, a slider technique, or a widget stacking technique. For example, the stacked element 425 displayed superimposed on the widget 412 may be referred to as a slide, a widget slide, a panel, a card-shaped stacked element, a widget card, a guide layer, an artificial intelligence layer, or a suggestion layer.

In the state 420, the at least one processor 210 may receive a user input (e.g., a swipe input) 428 for the stacked element 425. For example, the at least one processor 210 may change or switch a state of an electronic device 100 to a state 430 based on the user input.

The state 430 may be described as a state in which the widget 412 is disposed on the stacked element 425. For example, the at least one processor 210 may receive the user input 428 for the stacked element 425 while displaying the screen. For example, the at least one processor 210 may change a top card (or a top layer) included in the screen from the stacked element 425 to the widget 412 based on the user input 428 received for the stacked element 425. For example, the at least one processor 210 may display the visual indication 426 while displaying the widget 412 superimposed on the stacked element 425 based on the user input 428. For example, the visual indication 426 may be used to indicate a top card (or a top layer) among a plurality of stacked elements (e.g., stacked elements including the widget 412 and the stacked element 425). For example, the visual indication 426 may be used to indicate the number of the plurality of stacked elements.

The at least one processor 210 may receive a user input 432 (e.g., a swipe input) while displaying the widget 412 as a top card (or a top layer). For example, the at least one processor 210 may change the state of the electronic device 100 from the state 430 to a state 440 based on the user input 432.

The state 440 may be described as a state in which the stacked element 425 is displayed superimposed on the widget 412. For example, the at least one processor 210 may display the stacked element 425 superimposed on the widget 412 based on the user input 432. For example, a description of the state 440 may be referred to as the description of the state 420.

The at least one processor 210 may receive a user input 442 (e.g., a tap input) for the stacked element 425 while displaying the stacked element 425. For example, the at least one processor 210 may change the state of the electronic device 100 from the state 440 to a state 450 based on the user input 442.

The state 450 may be described as a state in which a screen in relation with the second function is displayed. For example, the at least one processor 210 may display a screen 452 via the display 208 based on the user input 442. For example, the screen 452 may be described as a screen in relation with the second function. For example, the screen 452 may be described as a screen for providing the second function. For example, the screen 452 may be described as a screen providing the second function. For example, the at least one processor 210 may execute the second function based on the user input 442.

The at least one processor 210 may receive a tap input (e.g., the user input 442) for the stacked element 425 while displaying the stacked element 425 displayed superimposed on the widget 412 via the display 208. For example, based on receiving the tap input, the at least one processor 210 may switch a screen displayed via the display 208 from a first screen including the stacked element 425 superimposed on the widget 412 to a second screen (e.g., the screen 452) for executing the preset function. For example, the at least one processor 210 may display the first screen including the widget 412 via the display 208 without displaying the stacked element 425 superimposed on the widget 412 based on receiving a user input to display the first screen after displaying the second screen.

Referring to FIG. 4, the operation of displaying the screen 452 based on the user input 442 received for the stacked element 425 has been described, but an embodiment of the disclosure is not limited thereto. For example, the at least one processor 210 may display a pop-up window (not illustrated) instead of the screen 452 based on the user input 442 received for the stacked element 425. For example, an extent of a first display area of the display 208 on which the screen 452 is displayed may be wider than an extent of a second display area of the display 208 on which the pop-up window is displayed. For example, the pop-up window may include a UI object 454 for providing the second function.

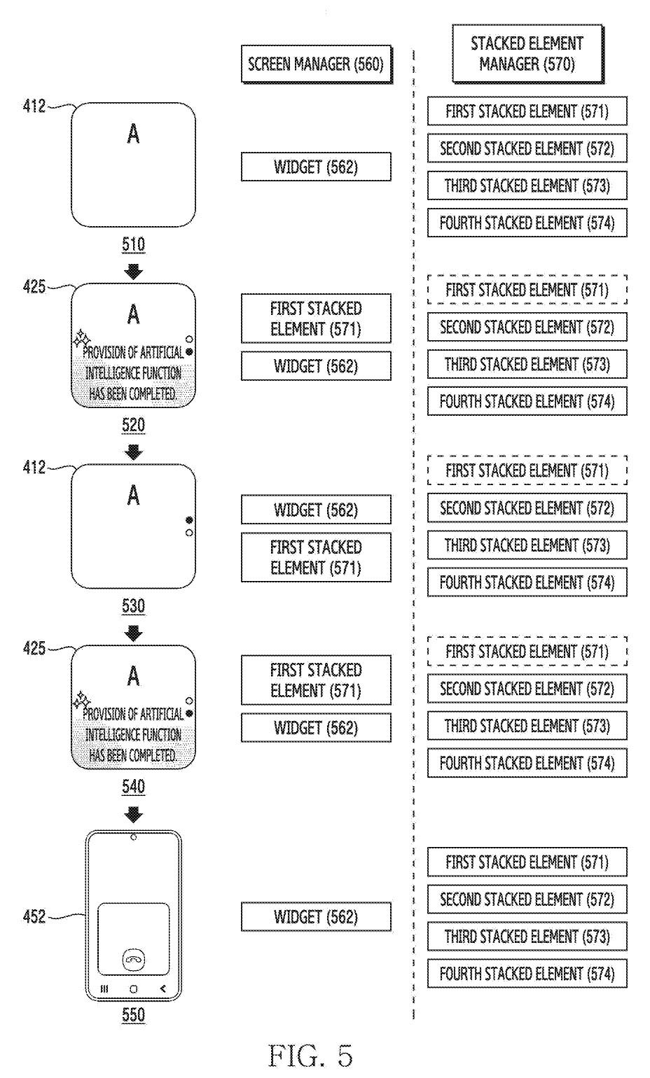

The at least one processor 210 may control or determine the widget 412 or the stacked element 425 to be displayed in a screen based on a screen manager (e.g., a screen manager 560 of FIG. 5) and/or a stacked element manager (e.g., a stacked element manager 570 of FIG. 5). For example, the operation of controlling the stacked element 425 is described and exemplified with reference to FIG. 5.

FIG. 5 illustrates an operation of an electronic device that changes a state of a widget according to a satisfied condition according to an embodiment of the disclosure.

Referring to FIG. 5, a description of each of states 510, 520, 530, 540, and 550 may be referred to as the description of each of the states 410, 420, 430, 440, and 450 of FIG. 4.

In the state 510, as a screen manager 560 manages a widget 562 as a top card (or a top layer), a widget 412 may be displayed via a display 208. A stacked element manager 570 may manage a plurality of stacked elements 571, 572, 573, and 574. Since the plurality of stacked elements are managed by the stacked element manager 570, a stacked element 425 may not be displayed via the display 208. For example, the widget 562 may correspond to the widget 412. For example, the first stacked element 571 may correspond to the stacked element 425. For example, the screen manager 560 may determine an element (e.g., the widget 412 or the stacked element 425) to be displayed via the display 208 according to a priority of the widget 412 or the stacked element 425. For example, the stacked element manager 570 may provide the screen manager 560 with the plurality of stacked elements that may be displayed superimposed on the widget according to a defined condition.

In the state 520, the stacked element manager 570 may provide the first stacked element 571 to the screen manager 560 according to determination that the defined condition for displaying the stacked element 425 is satisfied. For example, the screen manager 560 may manage a priority of the first stacked element 571 to be higher than a priority of the widget 562 based on the determination that the defined condition is satisfied. For example, since the priority of the first stacked element 571 is higher than the priority of the widget 562, the stacked element 425 may be displayed as a top card (or superimposed on the widget 412) via the display 208.

In the state 530, the screen manager 560 may manage the priority of the widget 562 to be higher than the priority of the first stacked element 571 based on a user input 428 received for the stacked element 425. For example, since the priority of the widget 562 is higher than the priority of the first stacked element 571, the widget 412 may be displayed as a top card (or superimposed on the stacked element 425) via the display 208.

In the state 540, the screen manager 560 may manage the priority of the first stacked element 571 to be higher than the priority of the widget 562 based on a user input 432 received for the widget 412. For example, since the priority of the first stacked element 571 is higher than the priority of the widget 562, the stacked element 425 may be displayed as a top card (or superimposed on the widget 412) via the display 208.

In the state 550, the stacked element manager 570 may refrain from or cease providing the first stacked element 571 to the screen manager 560 based on determination that another defined condition is satisfied. For example, the other defined condition may include receiving a user input 442 for the stacked element 425. For example, the screen manager 560 may discard the first stacked element 571 from the screen manager 560 based on the user input 442. For example, as the screen manager 560 discards the first stacked element 571, the stacked element 425 may not be displayed superimposed on the widget 412.

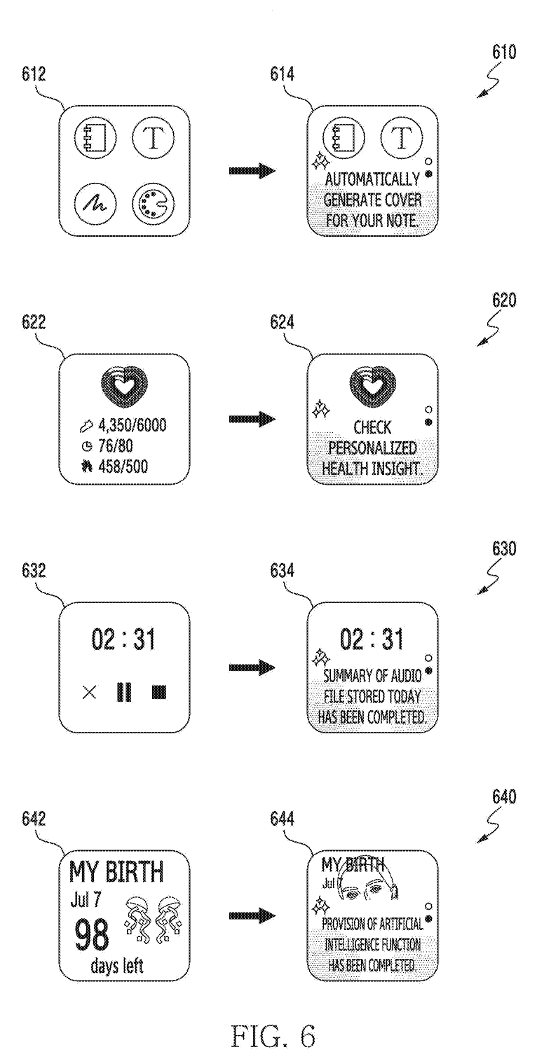

The at least one processor 210 may provide a plurality of features according to a plurality of software applications. For example, the at least one processor 210 may identify whether conditions, which vary according to each function, are satisfied. For example, the at least one processor 210 may display a stacked element (e.g., the stacked element 425) superimposed on the widget 412 based on determination that a condition corresponding to each software application is satisfied. For example, the condition corresponding to each software application is described and exemplified with reference to FIG. 6.

FIG. 6 illustrates an operation of an electronic device that displays stacked elements according to an embodiment of the disclosure.

Referring to FIG. 6, an example 610 may be described as an example in which a stacked element 614 for a software application for a note is displayed. For example, at least one processor 210 may display a screen (e.g., a home screen, a cover screen, a lock screen, and the like) including a widget 612 corresponding to the software application for a note via a display 208. For example, the at least one processor 210 may display the stacked element 614 superimposed on the widget 612 based on determination that a defined condition corresponding to the widget 612 is satisfied. For example, the defined condition corresponding to the widget 612 may include storing note information exceeding a specified amount in memory 206.

An example 620 may be described as an example in which a stacked element 624 for a software application for health is displayed. For example, the at least one processor 210 may display a screen (e.g., a home screen, a cover screen, a lock screen, and the like) including a widget 622 corresponding to the software application for health via the display 208. For example, the at least one processor 210 may display the stacked element 624 superimposed on the widget 622 based on determination that a defined condition corresponding to the widget 622 is satisfied. For example, the defined condition corresponding to the widget 622 may include that a sleep score of the user is less than a threshold score, the number of steps of the user exceeds a threshold number, or an amount of exercise of the user exceeding a threshold amount of exercise is identified.

As a non-limiting example, the at least one processor 210 may identify a type of information to be included in a stacked element (e.g., the stacked element 624). For example, the at least one processor 210 may display the stacked element including the information based on determination that the type of the information to be included in the stacked element is a first type. For example, the first type of information may be described as information having a first security level. For example, the first type of information may be described as information that may be disclosed to a third party. For example, the at least one processor 210 may refrain from or bypass displaying the information on the stacked element based on determination that the type of the information to be included in the stacked element is a second type. For example, the second type of information may be described as information having a second security level higher than the first security level. For example, the second type of information may be described as information (e.g., personal information, account information, a password, and the like) that is not disclosed to a third party. For example, based on the determination that the type of the information to be included in the stacked element is the second type, the at least one processor 210 may display only a graphical object 422 on the stacked element without displaying the second type of information. For example, the at least one processor 210 may display a user interface requesting user authentication before providing the second type of information. For example, the user interface requesting the user authentication may include a text suggesting the user authentication and/or an icon for performing the user authentication. For example, the at least one processor 210 may display the second type of information based on completion of authentication for the user.

An example 630 may be described as an example in which a stacked element 634 for a software application for recording audio is displayed. For example, the at least one processor 210 may display a screen (e.g., a home screen, a cover screen, a lock screen, and the like) including a widget 632 corresponding to the software application for recording audio, via the display 208. For example, the at least one processor 210 may display the stacked element 634 superimposed on the widget 632 based on determination that a defined condition corresponding to the widget 632 is satisfied. For example, the defined condition corresponding to the widget 632 may include that audio data less than a specified time length (e.g., 3 hours) is obtained through the software application for recording the audio.

An example 640 may be described as an example in which a stacked element 644 for a software application for a calendar is displayed. For example, the at least one processor 210 may display a screen (e.g., a home screen, a cover screen, a lock screen, and the like) including a widget 642 corresponding to the software application for a calendar via the display 208. For example, the at least one processor 210 may display the stacked element 644 superimposed on the widget 642 based on determination that a defined condition corresponding to the widget 642 is satisfied. For example, the defined condition corresponding to the widget 642 may include adding a new schedule based on a user input.

As a non-limiting example, the widget 412 may include a widget corresponding to a software application for recording audio. For example, the at least one processor 210 may display a stacked element 425 indicating that summary information is obtained from audio data superimposed on the widget 412, based on determination that the audio data less than a specified time length (e.g., 3 hours) has exceeded a preset time (e.g., 30 minutes) since the audio data was obtained through the software application for recording the audio. For example, the at least one processor 210 may display the stacked element 425 indicating that summary information is obtained from the audio data based on expiration of a timer of a preset time from a timing at which the audio data less than the specified time length is obtained, superimposed on the widget 412.

As a non-limiting example, the widget 412 may include a widget corresponding to a software application notifying weather. For example, the at least one processor 210 may display the stacked element 425 that suggests carrying an umbrella as precipitation is scheduled after a specified time (e.g., 30 minutes), based on determination that weather information provided to the user is updated and that the weather information indicates information on a probability of precipitation, superimposed on the widget 412.

As a non-limiting example, the widget 412 may include a widget corresponding to a software application for health. For example, based on determination that an amount of exercise (or the number of steps) of the user exceeds a threshold amount of exercise (or a threshold number of steps), the at least one processor 210 may display the stacked element 425 including an insight text (e.g., "Calorie burning was efficient. Check out the detailed insights."), superimposed on the widget 412.

For example, the at least one processor 210 may display the stacked element 425 to provide content to increase a sleep score of the user superimposed on the widget 412 based on the determination that the sleep score is less than a threshold score.

For example, the at least one processor 210 may display the stacked element 425 for encouraging movement of the user superimposed on the widget 412 based on the determination that the number of steps of the user exceeds a target number of steps corresponding to a specified ratio (e.g., 90%) of the threshold step.

As a non-limiting example, the widget 412 may include a widget corresponding to a software application for digital well-being. For example, the at least one processor 210 may display the stacked element 425 for encouraging a behavior of the user superimposed on the widget 412 based on determination that a time at which the display 208 is turned on exceeds a target time corresponding to a specified ratio of a threshold time.

As a non-limiting example, the widget 412 may include a widget corresponding to a software application for a calendar. For example, the at least one processor 210 may display the stacked element 425 that suggests changing a background image of the widget 412 to a new background image corresponding to a new schedule based on determination that the new schedule is identified through the software application for the calendar based on a user input, superimposed on the widget 412. For example, the at least one processor 210 may display the stacked element 425 that suggests changing to a new background image based on determination that the background image of the widget 412 is a template image, superimposed on the widget 412.

As a non-limiting example, the widget 412 may include a widget corresponding to a software application for translating of language. For example, the at least one processor 210 may display the stacked element 425 that suggests downloading language data of a foreign country based on obtaining information indicating that the user is scheduled to visit the foreign country, superimposed on the widget 412. For example, the at least one processor 210 may obtain information (e.g., profile information, usage history information) indicating that the user is scheduled to visit a foreign country through an analysis engine (e.g., personal data engine (PDE)).

As a non-limiting example, the widget 412 may include a widget corresponding to a software application for an Internet browser. For example, the at least one processor 210 may display the stacked element 425 that suggests checking a search result for a specified keyword or performing a search for the specified keyword based on identifying the specified keyword in a recent news page displayed via the display 208, superimposed on the widget 412. For example, the specified keyword may include a keyword for providing a summary function.

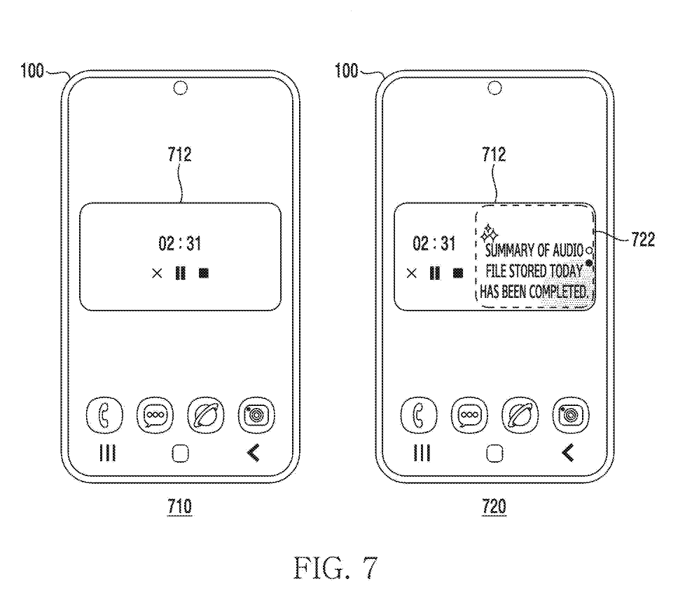

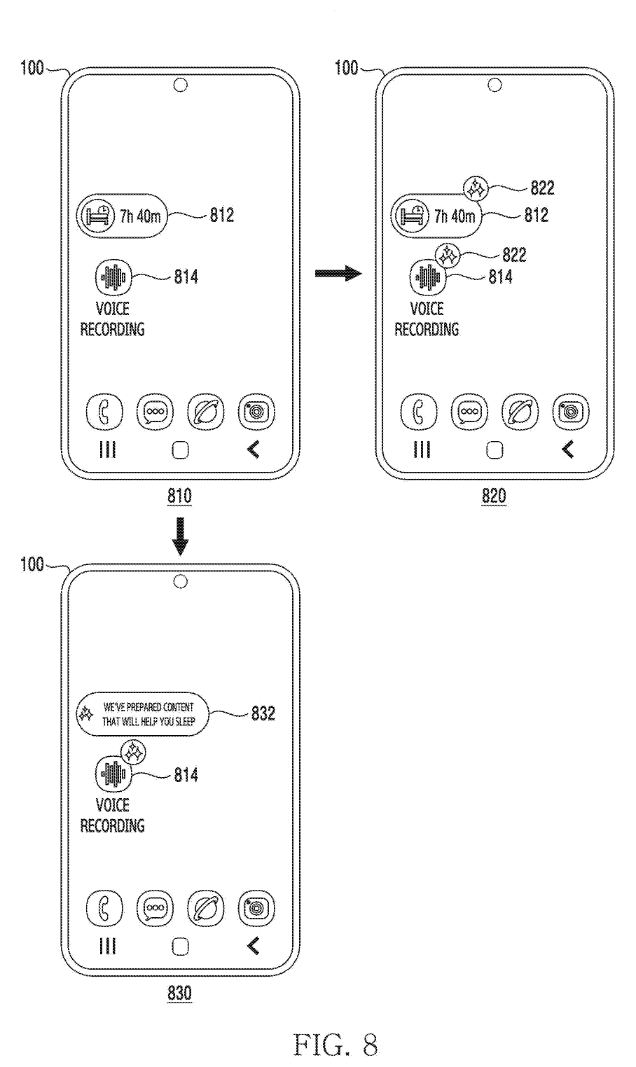

The at least one processor 210 may determine whether to display the stacked element 425 superimposed on the widget 412 based on a size of a widget (e.g., the widget 412) included in a screen (e.g., a home screen, a lock screen, a cover screen, and the like). For example, the operation of displaying the stacked element 425 or a visual object (e.g., a visual object 722 of FIG. 7) corresponding to the stacked element 425 based on the size of the widget is described and exemplified with reference to FIGS. 7 and 8.

FIGS. 7 and 8 illustrate operations of an electronic device that changes a state of a user interface (UI) object based on a size of a widget according to various embodiments of the disclosure.

Referring to FIG. 7, a state 710 may be described as a state in which a widget 712 having a size exceeding a first threshold size (e.g., a 4x2 size) (or a size equal to or greater than the first threshold size) is displayed. For example, at least one processor 210 may display a screen including the widget 712 exceeding the first threshold size via a display 208. For example, the at least one processor 210 may identify the size of the widget 712 included in the screen before displaying a stacked element 425 (or a visual object 722 corresponding to the stacked element 425). For example, the at least one processor 210 may display, based on determination that a size of a widget (e.g., a widget 412) is less than the first threshold size, the stacked element 425 superimposed on the widget 412. For example, the at least one processor 210 may display the visual object 722 corresponding to the stacked element 425 on the widget 712 instead of displaying the stacked element 425 superimposed on the widget based on determination that the size of the widget (e.g., the widget 712) exceeds the first threshold size.

A state 720 may be described as a state in which the visual object 722 corresponding to the stacked element 425 is displayed. For example, the visual object 722 corresponding to the stacked element 425 may include the same information as information indicated by the stacked element 425. For example, the at least one processor 210 may provide or execute the second function based on first information obtained through the widget 712. For example, the at least one processor 210 may display the visual object 722 indicating obtaining of the second information on the widget 712 by providing the second function. For example, the visual object 722 may include information included in the stacked element 425. For example, the visual object 722 may include at least one of a graphical object 422, a text 424, and/or a visual indication 426.

As a non-limiting example, information included in the visual object 722 corresponding to the stacked element 425 of the state 720 may include information included in the stacked element 425. For example, the information included in the visual object 722 corresponding to the stacked element 425 of the state 720 may include the information included in the stacked element 425 and additional information (or more specific information than the information). For example, since the size of the widget 712 is larger than the size of the widget 412, an amount of the information included in the visual object 722 corresponding to the stacked element 425 of the state 720 may be greater than an amount of information indicated by the stacked element 425.

As a non-limiting example, the at least one processor 210 may move information (e.g., a recording UI) included in the widget 712 when displaying the visual object 722 on the widget 712. For example, the at least one processor 210 may display the visual object 722 on the right side of the widget 712, and display information indicated by the widget 712 on the left side of the widget 712. However, an embodiment of the disclosure is not limited thereto. For example, the visual object 722 may be displayed on the left side of the widget 712, and information (e.g., a recording UI) indicated by the widget 712 may be displayed on the right side of the widget 712.

As a non-limiting example, displaying the visual object 722 on the widget 712 instead of displaying the stacked element 425 superimposed on the widget 712 may mean that a top card is not changed based on a swipe input. For example, the at least one processor 210 may maintain displaying the visual object 722 on the widget 712 based on a swipe input received for the visual object 722.

The at least one processor 210 may identify the size of the widget 412 before displaying the stacked element 425 displayed superimposed on the widget 412 via the display 208. For example, the at least one processor 210 may display, via the display 208, the stacked element 425 displayed superimposed on the widget 412 based on determination that the size of the widget 412 is smaller than a threshold size. The at least one processor 210 may display, on the widget 712, the visual object 722 corresponding to the stacked element 425 and suggesting execution of a preset function based on determination that the size of the widget 712 is larger than the threshold size.

As a non-limiting example, the at least one processor 210 may identify the size of the widget 412 being displayed via a display 220. For example, the at least one processor 210 may change the size of the widget 412 based on a size of a display area of the display 220. For example, the size of widget 412 may increase as the size of the display area increases. For example, the at least one processor 210 may display the stacked element 425 superimposed on the widget 412 as a condition for displaying the stacked element 425 is satisfied based on the size of the widget 412 identified as being smaller than the threshold size. For example, the at least one processor 210 may display the visual object 722 corresponding to the stacked element 425 superimposed on the widget 412 (or on the widget 712) as a condition for displaying the stacked element 425 is satisfied based on the size of the widget 412 identified as being larger than the threshold size.

As a non-limiting example, the operation of changing the size of the widget 412 based on the size of the display area of the above-described display 220 may be performed according to a user input of changing the size of the widget 412.

As a non-limiting example, in an embodiment in which the size of the display area of the above-described display 220 is changed, an electronic device 100, which is a foldable electronic device, may include a housing including a first housing part and a second housing part rotatably coupled to the first housing part. The electronic device 100, which is the foldable electronic device, may include a first display (e.g., a cover display corresponding to the first housing part) and a second display (e.g., a flexible display including a first portion corresponding to the first housing part and a second portion corresponding to the second housing part). For example, the electronic device 100, which is the foldable electronic device, may have a size of a display area of the first display while in a folded state. For example, the electronic device 100, which is the foldable electronic device, may have a size of a display area of the second display that is larger than the size of the display area of the first display while in an unfolded state.

Referring to FIG. 8, a state 810 may be described as a state in which a widget 812 and an icon 814 are displayed. For example, the widget 812 and the icon 814 may be included in a screen. At least one processor 210 may identify a size of the widget 812.

A state 820 may be described as a state in which a graphical object 822 is displayed on each of the widget 812 and the icon 814. For example, the at least one processor 210 may display the graphical object 822 for the widget 812 instead of displaying a stacked element 425 based on determination that the size of the widget 812 is less than a second threshold size (e.g., a 2x1 size) (or equal to or less than the second threshold size). For example, the graphical object 822 may correspond to the graphical object 422 of FIG. 4. For example, the graphical object 822 may be substantially the same as the graphical object 422 of FIG. 4.

The at least one processor 210 may provide a second function linked with a first function by using first information indicating a result of providing the first function provided through the widget 812. For example, the at least one processor 210 may display the graphical object 822 indicating that second information is obtained around the widget 812 based on obtaining the second information indicating a result of providing the second function by providing the second function. For example, the graphical object 822 may be at least partially superimposed on the widget 812.

The at least one processor 210 may provide a second function linked with a first function by using first information indicating a result of providing the first function provided through the icon 814. For example, the at least one processor 210 may display the graphical object 822 indicating that second information is obtained around the icon 814 based on obtaining the second information indicating a result of providing the second function by providing the second function. For example, the graphical object 822 may be at least partially superimposed on the icon 814.

Referring to the state 820, a state in which the graphical object 822 is displayed for a UI object (e.g., the widget 812 or the icon 814) is illustrated, but an embodiment of the disclosure is not limited thereto. For example, a state 830 may be described as a state in which a stacked element 832 is displayed. For example, the at least one processor 210 may display the stacked element 832 superimposed on the widget 812 based on obtaining the second information. For example, since an area for displaying information is small, the stacked element 832 may indicate less information than an amount of information indicated by the stacked element 425. For example, the stacked element 832 may indicate a text indicating that the second information is obtained.

Since a size of the icon 814 is a 1x1 size, it may be difficult for the icon 814 to display the text indicating that the second information is obtained. In other words, the at least one processor 210 may display the graphical object 822 around the icon 814 to indicate that the second information is obtained. For example, the graphical object 822 may be visually emphasized to indicate that the second information is obtained. For example, a flash effect (or a sparkle effect) may be applied to the graphical object 822. However, an embodiment of the disclosure is not limited thereto. For example, when the graphical object 822 is displayed for the icon 814, a color of the icon 814 may be changed. For example, a color of the icon 814 in the state 810 may be different from a color of the icon 814 in the state 820. For example, the flash effect may be applied to the icon 814 in the state 820.

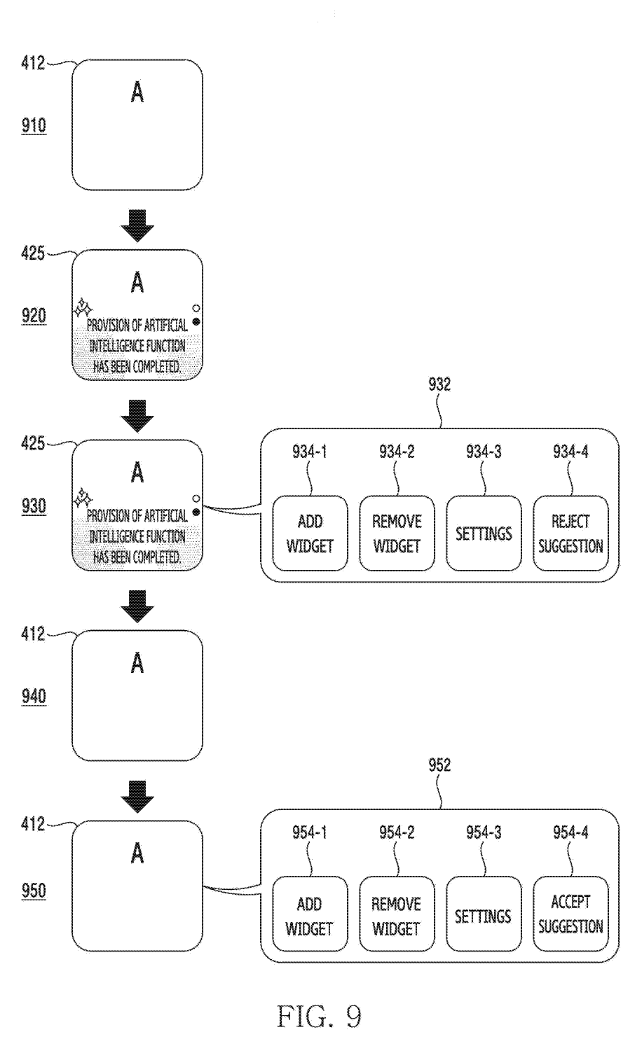

The at least one processor 210 may display, via a display 208, a user interface (e.g., a user interface 932 of FIG. 9) for controlling generation of the stacked element 425 based on a user input (e.g., a long press input) received for the stacked element 425. For example, the operation of displaying the user interface is described and exemplified with reference to FIG. 9.

FIG. 9 illustrates an operation of an electronic device that ceases displaying a stacked element based on a user input according to an embodiment of the disclosure.

Referring to FIG. 9, a state 910 may be described as a state in which a widget 412 is displayed. For example, a description of the state 910 may be referred to as the description of the state 410 of FIG. 4.

A state 920 may be described as a state in which a stacked element 425 is displayed superimposed on the widget 412. For example, a description of the state 920 may be referred to as the description of the state 420 of FIG. 4.

A state 930 may be described as a state in which a user interface 932 is displayed. For example, at least one processor 210 may display a screen (e.g., a lock screen, a cover screen, a home screen, and the like) that includes the stacked element 425 that is displayed superimposed on the widget 412, via a display 208. For example, the at least one processor 210 may receive a user input (e.g., a long press input) for the stacked element 425 while displaying the screen. For example, the at least one processor 210 may display the user interface 932 including UI objects 934-1, 934-2, 934-3, and 934-4 via the display 208 based on receiving the user input. For example, the user interface 932 may be described as a user interface for controlling the widget 412 or the stacked element 425 included in the screen. For example, the UI object 934-1 included in the user interface 932 may be used to add a new widget. For example, the UI object 934-2 included in the user interface 932 may be used to discard a widget (or a widget layer) (or a widget stack) included in the screen. For example, the UI object 934-3 included in the user interface 932 may be used to control a setting for a widget included in the screen. For example, the UI object 934-4 included in the user interface 932 may be used to manage or control the stacked element 425 that suggests use of the second function. For example, the UI object 934-4 may be described as a UI object to determine whether to display a stacked element that suggests a widget-related function (e.g., the second function). For example, the user interface 932 (or the UI objects 934-1, 934-2, 934-3, and 934-4) may be provided for each widget. For example, the at least one processor 210 may cease, refrain from, or bypass displaying the stacked element 425 superimposed on the widget 412 based on receiving a user input for the UI object 934-4 to manage the stacked element 425 suggesting the second function. For example, the at least one processor 210 may discard the stacked element 425 displayed superimposed on the widget 412 based on the user input with respect to the UI object 934-4.

The at least one processor 210 may receive a first user input (e.g., a long press input) for the stacked element 425 while displaying the stacked element 425 superimposed on the widget 412. The at least one processor 210 may display a UI object (e.g., the UI object 934-4) for controlling the stacked element 425 via the display 208 based on receiving the first user input. For example, the at least one processor 210 may display the widget 412 on the screen without displaying the stacked element 425 superimposed on the widget 412 based on receiving a second user input (e.g., a touch input or a tap input) for the UI object.

A state 940 may be described as a state in which the widget 412 is displayed as a top card (or a top layer) based on the user input with respect to the UI object 934-4. For example, the at least one processor 210 may display only the widget 412 via the display 208 without displaying the stacked element 425 superimposed on the widget 412 based on the user input.

A state 950 may be described as a state in which a user interface 952 is displayed. For example, the at least one processor 210 may display a screen (e.g., a lock screen, a cover screen, a home screen, and the like) including the widget 412, via the display 208. For example, the at least one processor 210 may receive a user input (e.g., a long press input) for the widget 412 while displaying the screen. For example, the at least one processor 210 may display the user interface 952 including UI objects 954-1, 954-2, 954-3, and 954-4 via the display 208 based on receiving the user input. For example, the user interface 952 may be described as a user interface for controlling the widget 412 or the stacked element 425 included in the screen. For example, the UI object 954-1 included in the user interface 952 may be used to add a new widget. For example, the UI object 954-2 included in the user interface 952 may be used to discard a widget (or a widget layer) (or a widget stack) included in the screen. For example, the UI object 954-3 included in the user interface 952 may be used to control a setting for a widget included in the screen. For example, the UI object 954-4 included in the user interface 952 may be used to manage or control the stacked element 425 that suggests use of the second function. For example, the at least one processor 210 may display the stacked element 425 superimposed on the widget 412 again, based on receiving a user input with respect to the UI object 954-4 to manage the stacked element 425 suggesting the second function. For example, the at least one processor 210 may display the stacked element 425 superimposed on the widget 412 based on the user input with respect to the UI object 954-4.

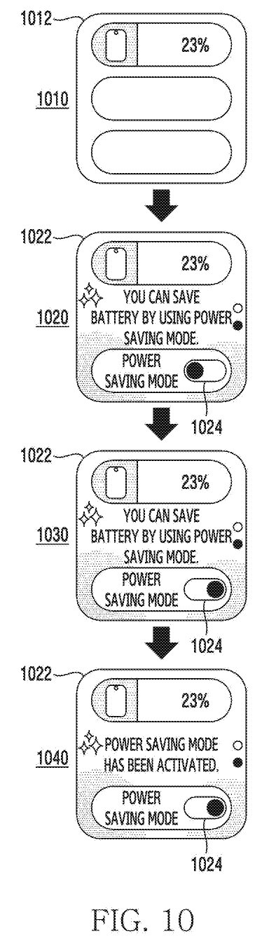

Referring to FIGS. 3 to 9, the operation of displaying the stacked element 425 indicating that the second function is provided has been described, but an embodiment of the disclosure is not limited thereto. For example, the at least one processor 210 may display a stacked element (e.g., a stacked element 1022 of FIG. 10) including a UI object (e.g., a UI object 1024 of FIG. 10) for controlling the second function based on determination that the second function is available, via the display 208. For example, the operation of displaying the stacked element including the UI object is described and exemplified with reference to FIG. 10.

FIG. 10 illustrates an operation of an electronic device that controls a function based on a user input with respect to a UI object according to an embodiment of the disclosure.

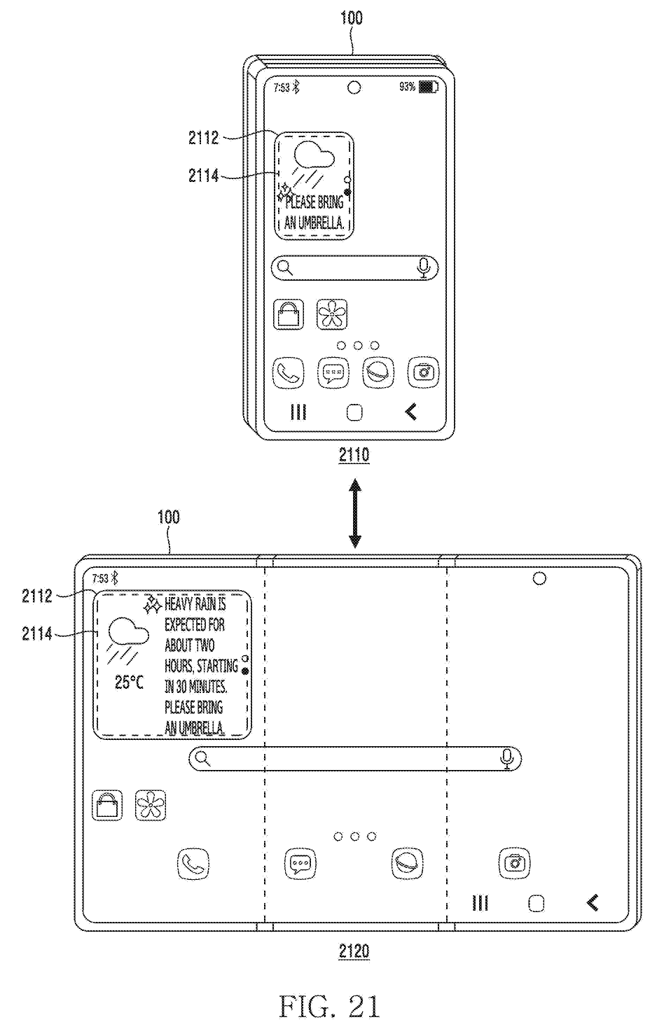

Referring to FIG. 10, a state 1010 may be described as a state in which a widget 1012 is displayed. For example, the widget 1012 may indicate a state of charge (SoC) of a battery (e.g., a battery 2189 of FIG. 21) of an electronic device 100. For example, at least one processor 210 may display a screen including the widget 1012 via a display 208.

A state 1020 may be described as a state in which a stacked element 1022 is displayed superimposed on the widget 1012. For example, the at least one processor 210 may identify or determine whether the second function is available while the widget 1012 is included in the screen. For example, the at least one processor 210 may display the stacked element 1022 that is at least partially superimposed on the widget 1012 based on the determination that the second function is available. For example, the stacked element 1022 may include a UI object 1024 to provide the second function (e.g., a power saving mode).

A state 1030 may be described as a state in which a user input is received with respect to the UI object 1024. For example, the at least one processor 210 may execute or provide the second function (e.g., a power saving mode) based on a user input with respect to the UI object 1024 while displaying the stacked element 1022.

A state 1040 may be described as a state in which the second function is provided based on the user input. For example, the at least one processor 210 may provide the second function based on the user input. However, an embodiment of the disclosure is not limited thereto. For example, the at least one processor 210 may receive another user input with respect to the UI object 1024 while providing the second function. For example, the at least one processor 210 may cease providing the second function based on receiving the other user input. For example, the at least one processor 210 may change or switch a state of the electronic device 100 to a state in which the second function is not provided based on the other user input.

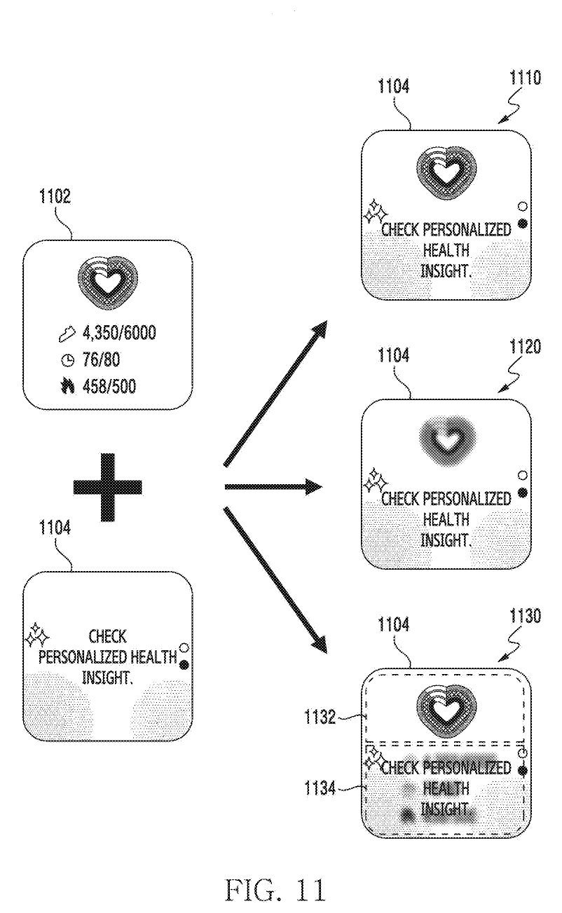

The at least one processor 210 may display a screen including a stacked element 425 at least partially superimposed on the widget 412 via the display 208. For example, the stacked element 425 may be provided according to various forms. For example, since a portion of the stacked element 425 is transparent, the user may recognize that the widget 412 is disposed under the stacked element 425. For example, the stacked element according to various embodiments is described and exemplified with reference to FIG. 11.

FIG. 11 illustrates an operation of an electronic device that displays a stacked element according to an embodiment of the disclosure.

Referring to FIG. 11, at least one processor 210 may display a stacked element 1104 superimposed on a widget 1102 according to a specified condition (e.g., the second function is available). For example, the widget 1102 may be an example of a widget 412. For example, the stacked element 1104 may be an example of a stacked element 425. For example, the at least one processor 210 may determine whether the specified condition is satisfied while the widget 1102 is included in a screen. For example, the at least one processor 210 may display the screen including the stacked element 1104 displayed superimposed on the widget 1102 via a display 208, based on the determination that the specified condition is satisfied. For example, the stacked element 1104 may indicate that it is displayed superimposed on the widget 1102 according to various methods.

An example 1110 may be described as an example in which at least a portion of the stacked element 1104 is transparent. For example, since the at least a portion of the stacked element 1104 is transparent, the user may recognize that the widget 1102 is located or disposed under the stacked element 1104 as the user recognizes the transparent portion of the stacked element 1104.

An example 1120 may be described as an example in which the at least a portion of the stacked element 1104 includes a blur filter. For example, a portion of the widget 1102 located or disposed under a portion of the stacked element 1104 including the blur filter may appear to have undergone blur processing. For example, the user may recognize that the widget 1102 is located or disposed under the stacked element 1104 as the user recognizes a portion of the widget 1102 on which blur processing has been performed through the stacked element 1104. For example, in the example 1120, a boundary between a portion of the stacked element 1104 including the blur filter and a remaining portion of the stacked element 1104 may be unclear (based on a gradation).

As a non-limiting example, transparency of the stacked element 1104 in the example 1110 may be different from transparency of the stacked element 1104 in the example 1120. For example, the transparency of the stacked element 1104 in the example 1110 may be higher than the transparency of the stacked element 1104 in the example 1120. However, an embodiment of the disclosure is not limited thereto. For example, the transparency of the stacked element 1104 in the example 1110 may be lower than the transparency of the stacked element 1104 in the example 1120.

The example 1130 may be described as an example in which a boundary between a portion 1134 of the stacked element 1104 including the blur filter and a portion 1132 not including the blur filter is clear. For example, since the portion 1132 does not include the blur filter, a portion of the widget 1102 located under the portion 1132 may be clearly visible to the user (than a case that the blur filter is included). For example, since the portion 1134 includes the blur filter, a remaining portion of the widget 1102 located under the portion 1134 may be blurry visible.

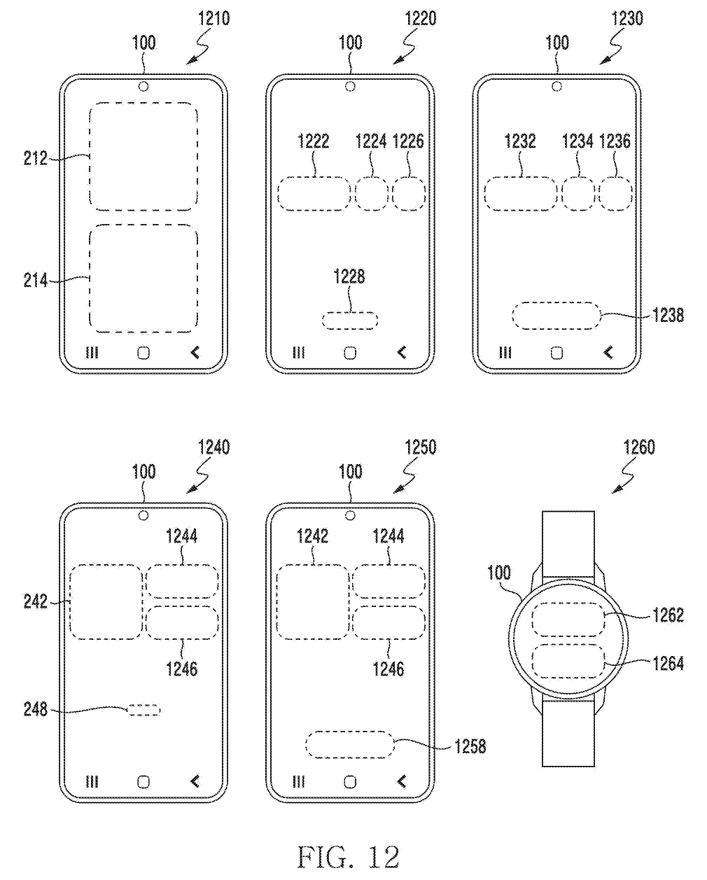

The widget 412 may be included on various screens. The widget 412 may be displayed through an electronic device 100 having various form factors. For example, the screen according to various examples including the widget 412 is described and exemplified with reference to FIG. 12.

FIG. 12 illustrates an area in which a widget may be displayed according to an embodiment of the disclosure.

Referring to FIG. 12, an example 1210 may be described as an example in which a widget is displayed on widget areas 1212 and 1214 having a defined size (e.g., a 4x4 size). For example, at least one processor 210 may display a widget having the defined size on at least one of the widget areas 1212 and 1214, based on a hub mode. For example, the hub mode may be described as a mode in which screens including a widget screen (or an always on display (AOD) screen switched from the widget screen) are displayed. For example, when a battery included in an electronic device 100 is charged (or when the electronic device 100 detects a defined magnetic force), the at least one processor 210 may display a widget having the defined size on a widget area (e.g., the widget area 1212 or the widget area 1214) according to the hub mode. For example, the widget having the defined size may correspond to the widget 412 of FIG. 4. For example, the widget having the defined size may indicate information that is the same as or similar to the information indicated by the widget 412 of FIG. 4.

An example 1220 may be described as an example in which a widget is displayed on widget areas 1222, 1224, 1226, and 1228 included in the AOD screen. For example, the at least one processor 210 may display a widget on at least a portion of the widget areas 1222, 1224, 1226, and 1228, while displaying the AOD screen. However, an embodiment of the disclosure is not limited thereto. For example, icons having a small size (e.g., a 1x1 size) may be displayed on the widget areas 1224 and 1226. As a non-limiting example, the widget displayed on the widget areas 1222, 1224, 1226, and 1228 included in the AOD screen may superimpose a stacked element different from a stacked element 425 superimposed on a widget (e.g., the widget 412) included in a home screen. For example, a blur effect may not be applied to a stacked element displayed on the AOD screen. For example, the stacked element displayed on the AOD screen may be opaque to reduce an amount of power consumed to display a screen. For example, the stacked element displayed on the AOD screen may be alternated with the widget according to a preset time. For example, the AOD screen may alternately include a stacked element or a widget according to the preset time.

An example 1230 may be described as an example in which a widget is displayed on widget areas 1232, 1234, 1236, and 1238 included in a lock screen. For example, the at least one processor 210 may display a widget on at least a portion of the widget areas 1232, 1234, 1236, and 1238 while displaying the lock screen. However, an embodiment of the disclosure is not limited thereto. For example, icons having a small size (e.g., 1x1 size) may be displayed on the widget areas 1234 and 1236. For example, a widget displayed on the widget area 1238 may be referred to as a Now Bar widget.

An example 1240 may be described as an example in which a widget is displayed on widget areas having various sizes. For example, the at least one processor 210 may display a widget on at least a portion of widget areas 1242, 1244, 1246, and 1248. For example, a size of a widget displayed on the widget area 1242 may be larger than a size of a widget displayed on the widget area 1244. For example, a size of a widget displayed on the widget area 1244 may be larger than a size of a widget displayed on the widget area 1248. For example, a bar-shaped widget may be displayed on the widget area 1248.

An example 1250 may be described as an example in which a widget is displayed on widget areas having various sizes. For example, the at least one processor 210 may display a widget on at least a portion of the widget areas 1242, 1244, 1246, and 1258. For example, a size of a widget displayed on the widget area 1242 may be larger than a size of a widget displayed on the widget area 1244. For example, a size of a widget displayed on the widget area 1244 may be smaller than a size of a widget displayed on the widget area 1258. For example, a bar-shaped widget may be displayed on the widget area 1258. For example, a widget displayed on the widget area 1258 may be referred to as a Now Bar widget.

An example 1260 may be described as an example in which a widget is displayed on widget areas 1262 and 1264 in an embodiment in which the electronic device 100 is a smart watch. For example, in the embodiment in which the electronic device 100 is a smart watch, the at least one processor 210 may display a widget on at least a portion of the widget areas 1262 and 1264 via a display 208.

For example, the electronic device 100 may display a widget for health data in real time by linking with an external electronic device (e.g., a smartphone, a smart watch, a smart ring, and the like). For example, the electronic device 100 may change a color represented by a stacked element based on the health data. For example, the electronic device 100 may display a stacked element representing an orange color based on health data that changes from a stable heart rate to an unstable heart rate. For example, the electronic device 100 may display a stacked element representing a red color based on health data indicating a fully unstable heart rate. For example, the electronic device 100 or the external electronic device may provide a vibration notification based on health data indicating the unstable heart rate.

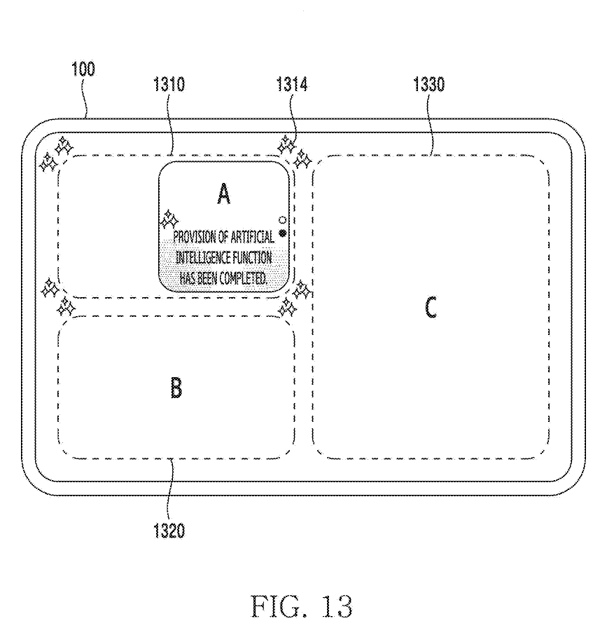

The at least one processor 210 may simultaneously execute a plurality of software applications. For example, the at least one processor 210 may display an execution screen of each software application on a portion of a display area of the display 208. For example, the portion of the display area may include the widget 412. For example, the operation of displaying the stacked element 425 on the portion of the display area is described and exemplified with reference to FIG. 13.

FIG. 13 illustrates an operation of an electronic device that displays a stacked element when a plurality of software applications are executed according to an embodiment of the disclosure.

Referring to FIG. 13, a display 208 of an electronic device 100 may include a display area. For example, at least one processor 210 may display an execution screen of a first software application through a first portion 1310 of the display area. For example, the at least one processor 210 may display an execution screen of a second software application through a second portion 1320 of the display area. For example, the at least one processor 210 may display an execution screen of a third software application through a third portion 1330 of the display area. For example, displaying an execution screen of a software application on at least a portion of the portions 1310, 1320, and 1330 of the display area may be referred to as a multi-window feature.

While displaying a first screen on the first portion 1310 of the display area, the at least one processor 210 may display a second screen different from the first screen on the second portion 1320 of the display area. For example, the first screen may include a widget 412. For example, the at least one processor 210 may display a stacked element 425 superimposed on the widget 412 as a specified condition is satisfied while displaying the second screen on the second portion 1320 of the display area. For example, when displaying the stacked element 425, the at least one processor 210 may display a visual representation 1314 in relation with the first portion 1310 of the display area in which the stacked element 425 is included. For example, the visual representation 1314 may be used to visually emphasize that the stacked element 425 is displayed (or generated).

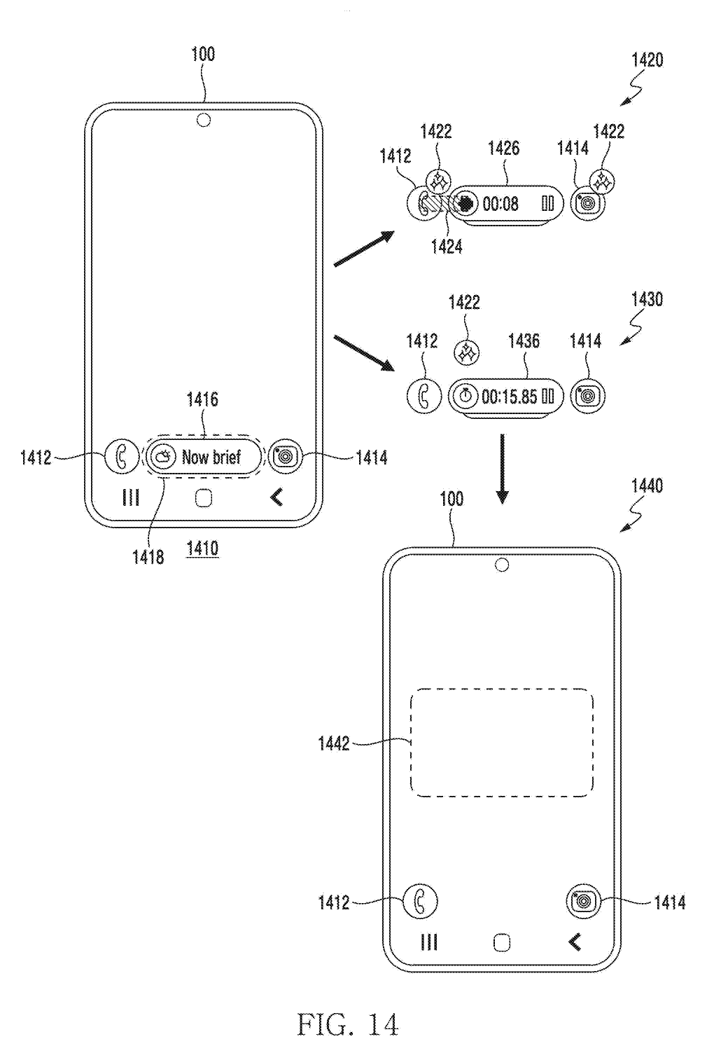

The at least one processor 210 may display a widget on a widget area while displaying a lock screen. For example, the at least one processor 210 may execute the second function based on a swipe input received for the widget. For example, the operation of executing the second function based on the swipe input received for the widget is described and exemplified with reference to FIG. 14.

FIG. 14 illustrates an operation of an electronic device that provides a function based on a user input with respect to a widget in a lock screen according to an embodiment of the disclosure.

Referring to FIG. 14, a state 1410 may be described as a state in which a lock screen is displayed. For example, at least one processor 210 may display a screen including a widget 1416, via a display 208. For example, the widget 1416 may be displayed on a widget area 1418 on the lock screen. For example, the lock screen may include icons 1412 and 1414. For example, the widget 1416 may be located or interposed between the icons. For example, the widget 1416 displayed on the widget area 1418 of the lock screen may be a widget provided according to a now bar function. The at least one processor 210 may display a graphical object 1422 indicating that the second function is available based on determination that the second function is available while an icon (e.g., the icon 1412 or an icon 1414) is included in the lock screen.

An example 1420 may be described as an example in which the graphical object 1422 indicating that the second function is available is displayed. For example, the graphical object 1422 may correspond to the graphical object 422 of FIG. 4. For example, the at least one processor 210 may display the graphical object 1422 around an icon (e.g., the icon 1412 or the icon 1414). For example, the graphical object 1422 may be located at a periphery of the icon. For example, the graphical object 1422 may be displayed at least partially superimposed on the icon.

The at least one processor 210 may receive a swipe input for a widget 1426 while the graphical object 1422 is arranged for the icon. For example, based on receiving a swipe input 1424 corresponding to a first direction from the widget 1426 toward the icon 1412, the at least one processor 210 may execute a function (e.g., an AI function in relation with a phone call) corresponding to the icon 1412 and provided through an artificial intelligence model. For example, based on receiving a swipe input corresponding to a second direction from the widget 1426 toward the icon 1414, the at least one processor 210 may execute a function (e.g., an AI function in relation with a camera) corresponding to the icon 1414 and provided through an artificial intelligence model.

An example 1430 may be described as an example in which the graphical object 1422 is displayed above the widget 1436. For example, the at least one processor 210 may determine a widget corresponding to a function as a top card among widgets that may be displayed in the widget area 1418 based on determination that the function provided through the artificial intelligence model is available. For example, the at least one processor 210 may display the widget (e.g., the widget 1436) determined as the top card on the widget area 1418. For example, the at least one processor 210 may identify whether a user input is received for the widget determined as the top card. For example, the at least one processor 210 may display another widget different from the widget determined as the top card on the widget area 1418 based on determination that the user input is not received for a specified time interval (e.g., 3 seconds) for the widget determined as the top card. For example, the at least one processor 210 may display the graphical object 1422 around the widget area 1418 when displaying the other widget.

An example 1440 may be described as an example in which an extended widget is displayed on a widget area 1442. For example, the at least one processor 210 may display the expanded widget on the widget area 1442 based on receiving the user input for the widget determined as the top card. For example, the extended widget displayed on the widget area 1442 may indicate at least a portion of information obtained as a function provided through the artificial intelligence model is provided.

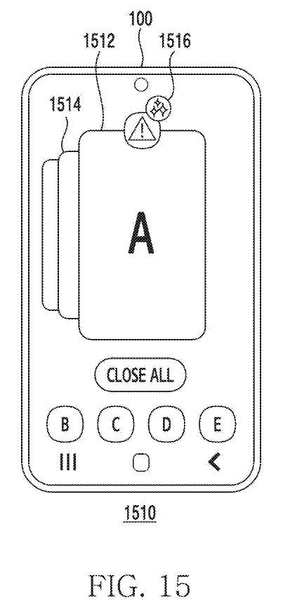

The at least one processor 210 may display a graphical object (e.g., a graphical object 1516 of FIG. 15) indicating that a function based on the artificial intelligence model is available on a recent apps screen. For example, the operation of displaying the graphical object on the recent apps screen is described and exemplified with reference to FIG. 15.

FIG. 15 illustrates an operation of an electronic device that displays a graphical object indicating that a feature is provided on a recent apps screen according to an embodiment of the disclosure.

Referring to FIG. 15, a state 1510 may be described as a state in which a recent apps screen is displayed. For example, at least one processor 210 may display the recent apps screen via a display 208 based on a user input. For example, since a recent apps list includes software applications recently executed by the user among software applications installed in an electronic device 100, the recent apps screen may be referred to as a recent screen, a recent UI, recent apps, a recent page, or a recent action list.

The recent apps screen may represent an execution screen of each of the software applications. For example, the recent apps screen may represent each execution screen of each software application. For example, the recent apps screen may include a visual object 1512 representing an execution screen of a first software application and a visual object 1514 representing an execution screen of a second software application.

The at least one processor 210 may determine or identify whether there is a function provided based on an artificial intelligence model among functions provided through a software application recently executed by the user. For example, the at least one processor 210 may display, via the display 208, a graphical object 1516 indicating that a function based on the artificial intelligence model is available, based on determination that there is a function provided based on the artificial intelligence model among the functions provided through a software application recently executed by the user. For example, the graphical object 1516 may correspond to the graphical object 422 of FIG. 4. For example, the graphical object 1516 may be located around the visual object 1512. For example, as the user recognizes the graphical object 1516, the user may recognize that a function based on the artificial intelligence model is available through the electronic device 100. As a non-limiting example, the at least one processor 210 may display a stacked element (e.g., the stacked element 425 of FIG. 4) superimposed on the visual object 1512 based on determination that there is a function provided based on the artificial intelligence model among functions provided through a recently executed software application.

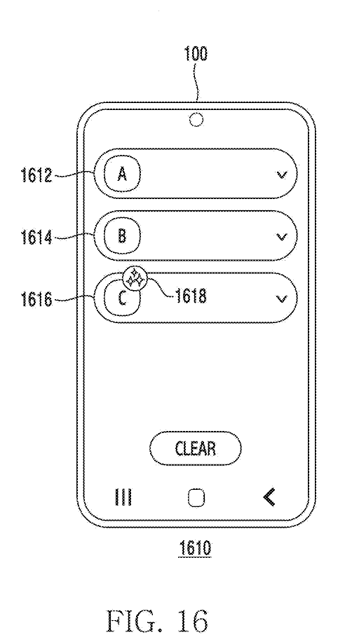

The at least one processor 210 may display a notification panel (or a notification window) based on a user input. For example, the at least one processor 210 may display a graphical object (e.g., a graphical object 1618 of FIG. 16) indicating that a function based on the artificial intelligence model is available on the notification panel. For example, the graphical object displayed on the notification panel is described and exemplified with reference to FIG. 16.

FIG. 16 illustrates an operation of an electronic device that displays a graphical object indicating that a feature is provided on a notification window according to an embodiment of the disclosure.

Referring to FIG. 16, a state 1610 may be described as a state in which a notification panel is displayed. For example, at least one processor 210 may provide a notification to the user through the notification panel based on identifying an event. For example, the notification panel may be referred to as the notification window. For example, the notification panel may include an item corresponding to each notification. For example, the notification panel may include items 1612, 1614, and 1616 indicating a plurality of notifications. For example, the at least one processor 210 may display a graphical object 1618 for the item 1616 based on determination that a function provided through an artificial intelligence model is available among functions corresponding to the item 1616. For example, the graphical object 1618 may correspond to the graphical object 422 of FIG. 4. For example, the graphical object 1618 may be at least partially superimposed on the item 1616. As a non-limiting example, the at least one processor 210 may display an extended item based on a user input with respect to a UI object (e.g., an arrow object) included in the item 1616. For example, the extended item may include a stacked element that corresponds to the item 1616 and suggests a function based on the artificial intelligence model. For example, a size of the extended item may be larger than a size of the item 1616.

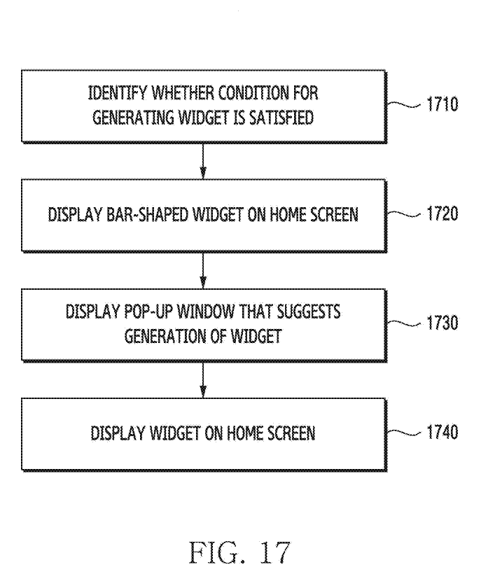

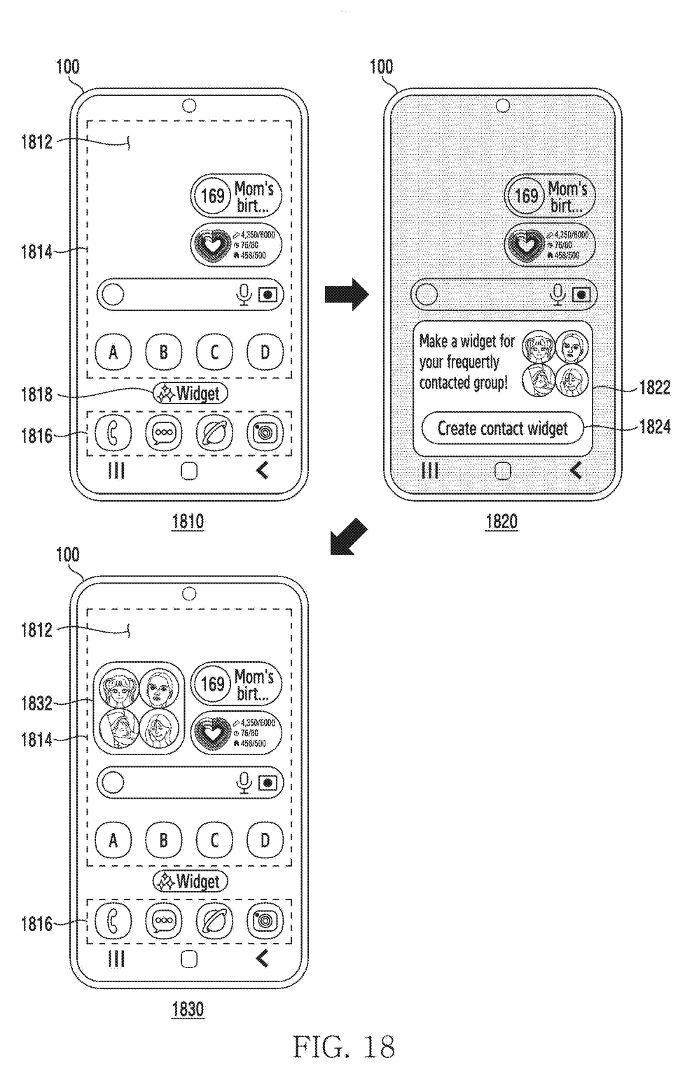

The at least one processor 210 may display a screen (e.g., a lock screen, a cover screen, and a home screen) including a widget 412, via a display 208. For example, the at least one processor 210 may install the widget 412 in the screen based on a user input for using the widget 412. For example, the number of user inputs for adding or including the widget 412 on the screen may be at least two. For example, it may be required to reduce the number of user inputs for displaying the widget 412 on the screen. For example, the at least one processor 210 may display a pop-up window (e.g., a pop-up window 1822 of FIG. 18) that suggests generation of the widget 412, via the display 208. For example, the at least one processor 210 may display the screen including the widget 412 via the display 208 based on a user input received for the pop-up window. For example, the operation of displaying the pop-up window is described and exemplified with reference to FIG. 17.

FIG. 17 is a flowchart indicating an operation of an electronic device that displays a pop-up window suggesting generation of a widget according to an embodiment of the disclosure.

This method may be executed by an electronic device 100 illustrated in FIG. 2 or at least one processor 210 of the electronic device 100. In the following embodiment of the disclosure, each operation may also be sequentially performed, but is not necessarily performed sequentially. For example, an order of each operation may also be changed, and at least two operations may also be performed in parallel.

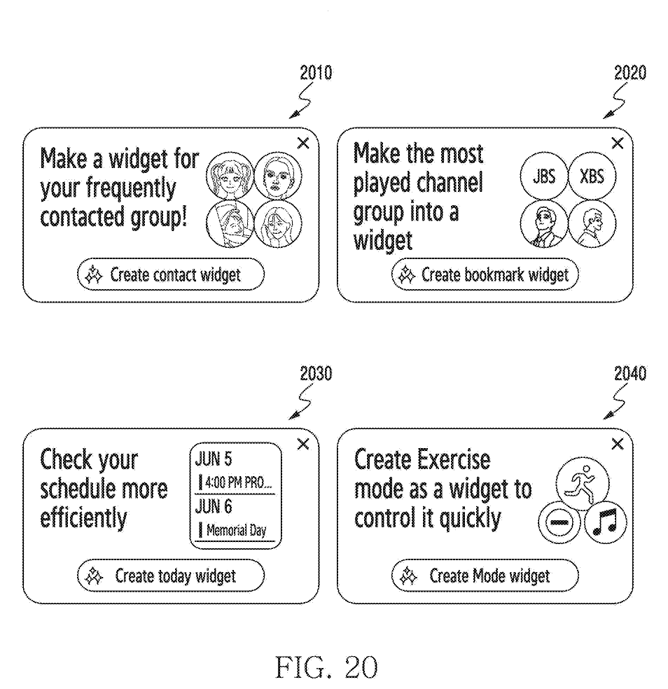

Referring to FIG. 17, in operation 1710, the at least one processor 210 may identify whether a condition for generating a widget (e.g., the widget 412 of FIG. 4 or a widget 1832 of FIG. 18) for providing a defined feature (e.g., the first function of FIG. 3) is satisfied. For example, the condition for generating the widget may include the number of times the defined feature is executed or the number of times a software application corresponding to the defined feature is executed. The condition will be described later with reference to FIG. 20.

In operation 1720, the at least one processor 210 may display a bar-shaped widget (e.g., a bar-shaped widget 1818 of FIG. 18) indicating that the condition is satisfied based on determination that the condition is satisfied, on a home screen (e.g., a home screen 1812 of FIG. 18). For example, a location on the home screen where the bar-shaped widget is displayed will be described later with reference to FIG. 18.

In operation 1730, the at least one processor 210 may display a pop-up window (e.g., a pop-up window 1822 of FIG. 18) that suggests generation of a widget to provide the defined feature based on receiving a first user input for the bar-shaped widget (e.g., the bar-shaped widget 1818 of FIG. 18), via a display 208. For example, the pop-up window may be at least partially superimposed on the home screen.

In operation 1740, the at least one processor 210 may display or add a widget for providing the defined feature on the home screen based on receiving a second user input for the pop-up window. The operation of adding a widget on the home screen based on the second user input received for the pop-up window is described and exemplified with reference to FIG. 18.

FIG. 18 illustrates an operation of an electronic device that displays a pop-up window based on a user input received for a bar-shaped widget according to an embodiment of the disclosure.

Referring to FIG. 18, a state 1810 may be described as a state in which a home screen 1812 is displayed. For example, at least one processor 210 may display the home screen 1812. For example, the home screen may include a first area 1814 and a second area 1816. For example, the first area may be described as an area in which an icon displayed via a display 208 is changed according to a swipe input. For example, the second area may be described as an area in which the icon displayed via the display 208 is maintained independently of the swipe input. For example, the first area may be referred to as a main area. For example, the second area may be referred to as a lower area or an icon tray area.

The at least one processor 210 may display a bar-shaped widget 1818 on the home screen 1812 based on determination that a condition for generating a widget providing a defined feature is satisfied. For example, the bar-shaped widget 1818 may be located or interposed between the first area and the second area. The at least one processor 210 may receive a first user input (e.g., a touch input or a tap input) for the bar-shaped widget 1818 while displaying the bar-shaped widget 1818.

A state 1820 may be described as a state in which a pop-up window 1822 is displayed based on the first user input received for the bar-shaped widget 1818. For example, the at least one processor 210 may display the pop-up window 1822 suggesting generation of a widget that provides the defined feature based on receiving the first user input, on the home screen 1812. For example, while the pop-up window 1822 is displayed, at least a portion of the home screen 1812 may be represented as blur processing has been performed. The pop-up window 1822 may include information (e.g., a text or an image) suggesting generation of a widget that provides the defined feature. For example, the pop-up window 1822 may include a UI object 1824 for generating a widget that provides the defined feature. The at least one processor 210 may receive a second user input (e.g., a touch input or a tap input) for the UI object 1824.

A state 1830 may be described as a state in which a widget 1832 is added to the home screen 1812 based on the second user input. For example, the at least one processor 210 may add or display the widget 1832 that provides the defined feature on the home screen 1812 based on receiving the second user input.

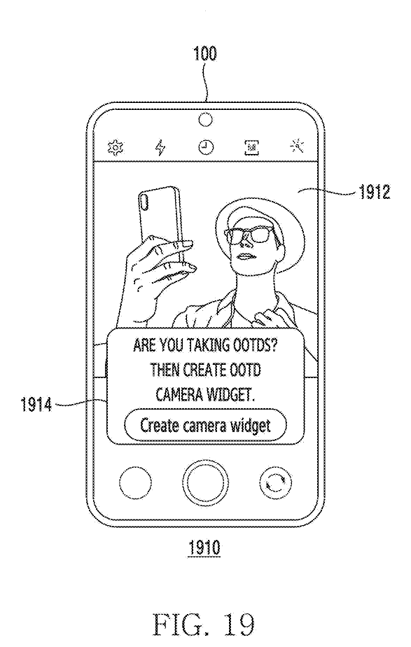

Referring to FIG. 18, the operation of displaying the pop-up window 1822 on the home screen 1812 has been described, but an embodiment of the disclosure is not limited thereto. For example, the at least one processor 210 may display a pop-up window (e.g., a pop-up window 1914 of FIG. 19) on an execution screen (e.g., an execution screen 1912 of FIG. 19) of a software application when executing the software application corresponding to the defined feature, based on determination that a condition for generating a widget that provides the defined feature is satisfied. For example, the operation of displaying the pop-up window on the execution screen is described and exemplified with reference to FIG. 19.

FIG. 19 illustrates an operation of an electronic device that displays a pop-up window when a software application is executed according to an embodiment of the disclosure.

Referring to FIG. 19, a state 1910 may be described as a state in which a pop-up window 1914 is displayed on an execution screen 1912 of the software application. For example, at least one processor 210 may identify whether a condition for displaying the pop-up window 1914 is satisfied. For example, the pop-up window 1914 may be described as a window suggesting generation of a widget that provides a defined feature. For example, the at least one processor 210 may display the pop-up window 1914 on the execution screen 1912 based on determination that the condition is satisfied when executing a software application. For example, the pop-up window 1914 may include information (e.g., a text or an image) suggesting generation of a widget that provides the defined feature. For example, in an embodiment in which the defined feature is a photography function, the information may include a text suggesting generation of a widget that provides an outfit of the day (OOTD) feature.

The at least one processor 210 may display a pop-up window 1822 based on determination that a condition for displaying the pop-up window 1822 is satisfied. For example, the condition for displaying the pop-up window 1822 and pop-up windows are described and exemplified with reference to FIG. 20.

FIG. 20 illustrates a pop-up window according to an embodiment of the disclosure.

Referring to FIG. 20, an example 2010 may be described as an example of a pop-up window suggesting generation of a contact widget. For example, at least one processor 210 may display a pop-up window of the example 2010 based on determination that a condition for generating the widget is satisfied. For example, in an embodiment of the pop-up window suggesting generation of the contact widget, the condition may include that a contact of a specified category (e.g., favorite or emergency) is identified, or the number of times the contact has been accessed exceeds a preset number of times.

An example 2020 may be described as an example of a pop-up window that suggests generation of a bookmark widget. For example, the at least one processor 210 may display a pop-up window of the example 2020 based on determination that a condition for generating the widget is satisfied. For example, in an embodiment of the pop-up window that suggests generation of the bookmark widget, the condition may include that content of a specified channel is provided more than a preset number of times.

An example 2030 may be described as an example of a pop-up window that suggests generation of a reminder widget. For example, the at least one processor 210 may display a pop-up window of the example 2030 based on determination that a condition for generating the widget is satisfied. For example, in an embodiment of the pop-up window that suggests generation of the reminder widget, the condition may include that the reminder widget is not included in a screen (e.g., a home screen) and that a reminder application is executed more than a preset number of times (e.g., 3) for a specified period (e.g., 3 days). The condition may include that after reminders are completed by a preset number of times, the reminder application is executed more than a preset number of times for a specified period.

An example 2040 may be described as an example of a pop-up window that suggests generation of a mode switching widget. For example, the at least one processor 210 may display a pop-up window of the example 2040 based on determination that a condition for generating the widget is satisfied. For example, in an embodiment of the pop-up window that suggests generation of the mode switching widget, the condition may include that a preset mode is executed by a threshold number of times for a specified period.

As a non-limiting example, in an embodiment of a pop-up window that suggests generation of a widget indicating an SoC of a battery, the at least one processor 210 may display the pop-up window based on determination that an electronic device 100 is connected to a wearable device (e.g., a smart watch, a smart ring, an earbud, and the like).

As a non-limiting example, in an embodiment of a pop-up window suggesting generation of a calendar widget, the at least one processor 210 may display the pop-up window based on determination that the calendar widget is not included in a screen (e.g., a home screen), one or more schedules are identified, and a calendar application is executed by a preset number of times for a specified period.

As a non-limiting example, in an embodiment of a pop-up window suggesting generation of a camera widget, the at least one processor 210 may display the pop-up window based on determination that at least one of a place where a camera application is executed, a time when the camera application is executed, and an object identified in a field of view (FOV) of a camera included in the electronic device 100 is repeatedly identified for a specified period.

As a non-limiting example, in an embodiment of a pop-up window suggesting generation of a device management widget (or a device care widget), the at least one processor 210 may display the pop-up window based on determination that a defined feature (e.g., optimization of a device) is executed by a threshold number of times or that a resource of the electronic device 100 exceeds a threshold resource.

As a non-limiting example, in an embodiment of a pop-up window suggesting generation of a handwriting (or note) widget, the at least one processor 210 may display the pop-up window based on determination that the same note is executed by a threshold number of times in a handwriting application.

As a non-limiting example, in an embodiment of a pop-up window suggesting generation of a weather widget, the at least one processor 210 may display the pop-up window based on determination that weather information for a specified city among cities included in a list determined by a user input is provided by a threshold number of times.

As a non-limiting example, in an embodiment of a pop-up window suggesting generation of a news widget, the at least one processor 210 may display the pop-up window based on determination that a news application is executed by a threshold number of times for a specified period or the news is provided by a threshold number of times.

As a non-limiting example, in an embodiment of a pop-up window suggesting generation of a recording widget of audio, the at least one processor 210 may display the pop-up window based on determination that a recording application is executed by a threshold number of times for a specified period.

As a non-limiting example, in an embodiment of a pop-up window suggesting generation of a gallery widget, the at least one processor 210 may display the pop-up window based on information (e.g., a preference, a number of times displayed via a display 208, an object identified in an image, and the like) on images stored in memory 206.

As a non-limiting example, in an embodiment of a pop-up window suggesting generation of a translation widget of a language, the at least one processor 210 may display the pop-up window based on determination that the translation widget is not included in the screen and that a travel is identified.

As described above, the at least one processor 210 may display a pop-up window suggesting generation of a widget based on whether a preset condition is satisfied. However, an embodiment of the disclosure is not limited thereto. For example, the at least one processor 210 may determine whether to display a pop-up window suggesting generation of a widget based on providing user data obtained through the electronic device 100 to a pre-trained model (or an artificial intelligence model (e.g., a personal data engine (PDE))). For example, the artificial intelligence model used to determine whether to display a pop-up window may be included in an external electronic device (e.g., a server). However, an embodiment of the disclosure is not limited thereto. For example, the artificial intelligence model may be included in the electronic device 100.

As a non-limiting example, a pop-up window suggesting generation of a widget may be displayed on a home screen 1812, but an embodiment of the disclosure is not limited thereto. For example, the pop-up window suggesting generation of a widget may be displayed on an execution screen (e.g., the execution screen 1912 of FIG. 19) of a specified software application.

The electronic device 100 may include a foldable electronic device. For example, the foldable electronic device may include a multi-foldable electronic device. For example, in an embodiment in which the electronic device 100 is the multi-foldable electronic device, the electronic device 100 may change a size of a widget or a stacked element according to a state (e.g., a folded state or an unfolded state) of the electronic device 100. For example, the operation of changing the size of the widget or the stacked element based on the state of the electronic device 100 is described and exemplified with reference to FIG. 21.

FIG. 21 illustrates an operation of a foldable electronic device displaying a stacked element according to an embodiment of the disclosure.

Referring to FIG. 21, an example 2110 may be described as an example of displaying a stacked element 2114 superimposed on a widget 2112. For example, an electronic device 100 may identify an event for displaying the stacked element 2114 superimposed on the widget while displaying the widget 2112 included in a screen (e.g., a home screen). For example, the electronic device 100 may display the stacked element 2114 superimposed on the widget 2112 included in the screen based on the event. For example, the widget 2112 may include a weather widget. For example, the stacked element 2114 may include a first text (e.g., “Please bring an umbrella.”) having a first length. For example, a foldable electronic device of the example 2110 may be in a folded state. For example, the electronic device 100 in the folded state of the example 2110 may include a display area having a first size. For example, the stacked element 2114 and/or the widget 2112 may be included in the display area having the first size.

An example 2120 may be described as an example in which the widget 2112 having a changed size and the stacked element 2114 having a changed size are displayed. For example, in an embodiment in which the electronic device 100 is the foldable electronic device, the electronic device 100 may be in an unfolded state. For example, a size of a display area capable of displaying content in the unfolded state may be wider than a size of a display area capable of displaying content in the folded state. For example, as the size of the display area increases, a size of the widget 2112 (or the stacked element 2114) may increase. For example, since the size of the stacked element 2114 increases, a second length of a text (e.g., “Heavy rain is expected for about two hours, starting in 30 minutes. Please bring an umbrella.”) included in the stacked element 2114 of the example 2120 may be longer than the first length of the text included in the stacked element 2114 of the example 2110. As a non-limiting example, the widget 2112 of the example 2120 may include additional information (e.g., a temperature, 25 degrees Celsius) in addition to information included in the widget 2112 of the example 2110.

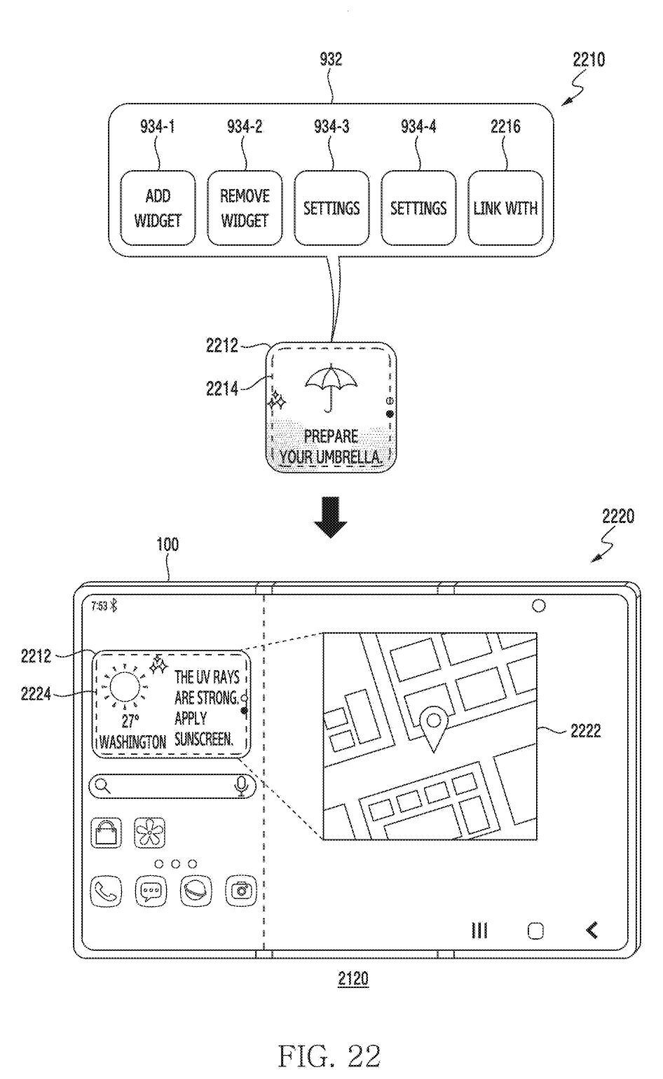

FIG. 22 illustrates an operation of a foldable electronic device displaying an additional stacked element according to an embodiment of the disclosure.

Referring to FIG. 22, an example 2210 may be described as an example of displaying a UI object 2216 for linking a software application for a widget 2212 with another software application. For example, at least one processor 210 may display a user interface 932 based on receiving a defined user input (e.g., a long press input) with respect to the widget 2212. For example, the user interface 932 may be described as an interface for suggesting or managing generation of a stacked element (e.g., a stacked element 425). For example, a description of UI objects 934-1, 934-2, 934-3, and 934-4 included in the user interface 932 may be referred to as the description of the state 930 of FIG. 9.

As a non-limiting example, in an embodiment in which the widget 2212 is a weather widget, a stacked element 2214 may indicate weather information of a current place where the electronic device 100 is located.

As a non-limiting example, the user interface 932 may further include a UI object 2216. For example, the UI object 2216 may be described as a UI object for linking a software application corresponding to a widget (e.g., the widget 2212) with another software application. For example, the UI object 2216 may be described as a UI object for providing a linked function by linking a software application corresponding to the widget with another software application. For example, while displaying the UI object 2216, the at least one processor 210 may display an additional stacked element 2224 superimposed on the widget 2212 based on a user input (e.g., a touch input or a tap input) received for the UI object 2216.

An example 2220 may be described as an example of displaying the additional stacked element 2224 on the widget 2212. For example, the at least one processor 210 may display a display content 2222 based on the user input received for the UI object 2216. For example, the display content 2222 displayed based on the UI object 2216 may be described as an object provided through another software application (e.g., a map software application) that is linked with a software application (e.g., a weather software application) corresponding to the widget 2212.

For example, the at least one processor 210 may receive a user input for the display content 2222 while displaying the display content 2222. For example, while displaying the display content 2222, the at least one processor 210 may receive a user input selecting or determining a specified location (or point) in the map in an embodiment in which the display content 2222 is a map. For example, the at least one processor 210 may display the additional stacked element 2224 indicating weather of the specified location superimposed on the widget 2212, based on the user input of selecting the specified location. For example, the additional stacked element 2224 may include information (e.g., a region name, a temperature, weather, and the like) indicating the weather at the specified location. For example, the additional stacked element 2224 may include a text (e.g., “The UV rays are strong. Apply sunscreen.”) based on the weather software application.

The at least one processor 210 may display the widget 2212 or the stacked element 2214 instead of displaying the additional stacked element 2224 based on a swipe input received for the additional stacked element 2224. For example, the at least one processor 210 may display the stacked element 2214 based on the swipe input in a first direction (e.g., an upward direction). For example, the at least one processor 210 may display the widget 2212 based on the swipe input in a second direction (e.g., a downward direction).

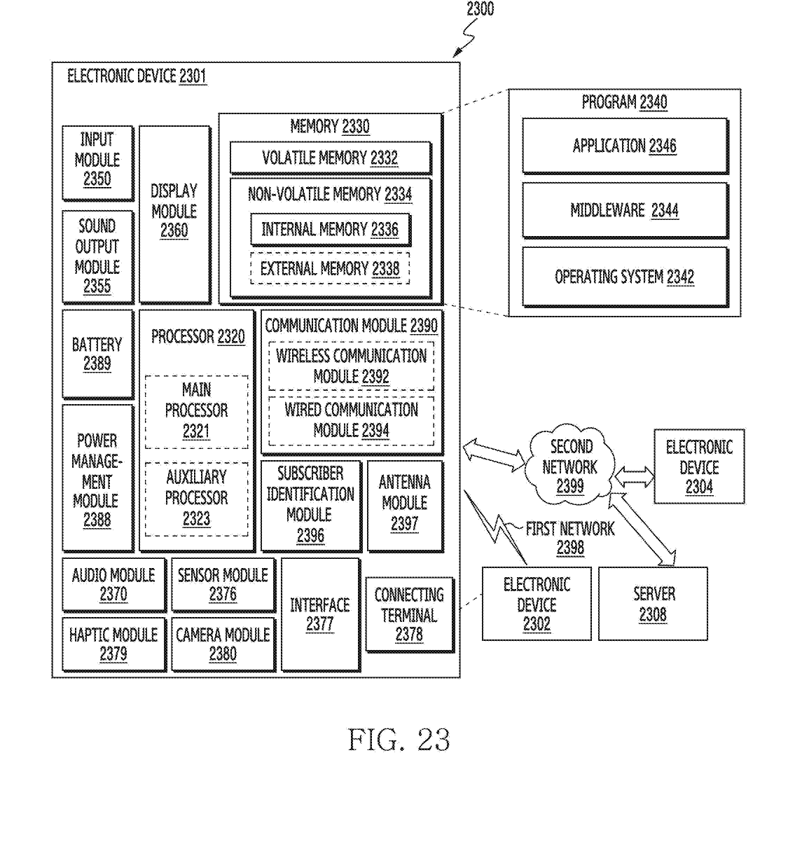

FIG. 23 is a block diagram illustrating an electronic device 2301 in a network environment 2300 according to various embodiments.

Referring to FIG. 23, the electronic device 2301 in the network environment 2300 may communicate with an electronic device 2302 via a first network 2398 (e.g., a short-range wireless communication network), or at least one of an electronic device 2304 or a server 2308 via a second network 2399 (e.g., a long-range wireless communication network). According to an embodiment, the electronic device 2301 may communicate with the electronic device 2304 via the server 2308. According to an embodiment, the electronic device 2301 may include a processor 2320, memory 2330, an input module 2350, a sound output module 2355, a display module 2360, an audio module 2370, a sensor module 2376, an interface 2377, a connecting terminal 2378, a haptic module 2379, a camera module 2380, a power management module 2388, a battery 2389, a communication module 2390, a subscriber identification module(SIM) 2396, or an antenna module 2397. In some embodiments, at least one of the components (e.g., the connecting terminal 2378) may be omitted from the electronic device 2301, or one or more other components may be added in the electronic device 2301. In some embodiments, some of the components (e.g., the sensor module 2376, the camera module 2380, or the antenna module 2397) may be implemented as a single component (e.g., the display module 2360).

The processor 2320 may execute, for example, software (e.g., a program 2340) to control at least one other component (e.g., a hardware or software component) of the electronic device 2301 coupled with the processor 2320, and may perform various data processing or computation. According to an embodiment, as at least part of the data processing or computation, the processor 2320 may store a command or data received from another component (e.g., the sensor module 2376 or the communication module 2390) in volatile memory 2332, process the command or the data stored in the volatile memory 2332, and store resulting data in non-volatile memory 2334. According to an embodiment, the processor 2320 may include a main processor 2321 (e.g., a central processing unit (CPU) or an application processor (AP)), or an auxiliary processor 2323 (e.g., a graphics processing unit (GPU), a neural processing unit (NPU), an image signal processor (ISP), a sensor hub processor, or a communication processor (CP)) that is operable independently from, or in conjunction with, the main processor 2321. For example, when the electronic device 2301 includes the main processor 2321 and the auxiliary processor 2323, the auxiliary processor 2323 may be adapted to consume less power than the main processor 2321, or to be specific to a specified function. The auxiliary processor 2323 may be implemented as separate from, or as part of the main processor 2321.

The auxiliary processor 2323 may control at least some of functions or states related to at least one component (e.g., the display module 2360, the sensor module 2376, or the communication module 2390) among the components of the electronic device 2301, instead of the main processor 2321 while the main processor 2321 is in an inactive (e.g., sleep) state, or together with the main processor 2321 while the main processor 2321 is in an active state (e.g., executing an application). According to an embodiment, the auxiliary processor 2323 (e.g., an image signal processor or a communication processor) may be implemented as part of another component (e.g., the camera module 2380 or the communication module 2390) functionally related to the auxiliary processor 2323. According to an embodiment, the auxiliary processor 2323 (e.g., the neural processing unit) may include a hardware structure specified for artificial intelligence model processing. An artificial intelligence model may be generated by machine learning. Such learning may be performed, e.g., by the electronic device 2301 where the artificial intelligence is performed or via a separate server (e.g., the server 2308). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 2330 may store various data used by at least one component (e.g., the processor 2320 or the sensor module 2376) of the electronic device 2301. The various data may include, for example, software (e.g., the program 2340) and input data or output data for a command related thereto. The memory 2330 may include the volatile memory 2332 or the non-volatile memory 2334.

The program 2340 may be stored in the memory 2330 as software, and may include, for example, an operating system (OS) 2342, middleware 2344, or an application 2346.

The input module 2350 may receive a command or data to be used by another component (e.g., the processor 2320) of the electronic device 2301, from the outside (e.g., a user) of the electronic device 2301. The input module 2350 may include, for example, a microphone, a mouse, a keyboard, a key (e.g., a button), or a digital pen (e.g., a stylus pen).

The sound output module 2355 may output sound signals to the outside of the electronic device 2301. The sound output module 2355 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 2360 may visually provide information to the outside (e.g., a user) of the electronic device 2301. The display module 2360 may include, for example, a display, a hologram device, or a projector and control circuitry to control a corresponding one of the display, hologram device, and projector. According to an embodiment, the display module 2360 may include a touch sensor adapted to detect a touch, or a pressure sensor adapted to measure the intensity of force incurred by the touch.

The audio module 2370 may convert a sound into an electrical signal and vice versa. According to an embodiment, the audio module 2370 may obtain the sound via the input module 2350, or output the sound via the sound output module 2355 or a headphone of an external electronic device (e.g., an electronic device 2302) directly (e.g., wiredly) or wirelessly coupled with the electronic device 2301.

The sensor module 2376 may detect an operational state (e.g., power or temperature) of the electronic device 2301 or an environmental state (e.g., a state of a user) external to the electronic device 2301, and then generate an electrical signal or data value corresponding to the detected state. According to an embodiment, the sensor module 2376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 2377 may support one or more specified protocols to be used for the electronic device 2301 to be coupled with the external electronic device (e.g., the electronic device 2302) directly (e.g., wiredly) or wirelessly. According to an embodiment, the interface 2377 may include, for example, a high definition multimedia interface (HDMI), a universal serial bus (USB) interface, a secure digital (SD) card interface, or an audio interface.

A connecting terminal 2378 may include a connector via which the electronic device 2301 may be physically connected with the external electronic device (e.g., the electronic device 2302). According to an embodiment, the connecting terminal 2378 may include, for example, an HDMI connector, a USB connector, an SD card connector, or an audio connector (e.g., a headphone connector).

The haptic module 2379 may convert an electrical signal into a mechanical stimulus (e.g., a vibration or a movement) or electrical stimulus which may be recognized by a user via his tactile sensation or kinesthetic sensation. According to an embodiment, the haptic module 2379 may include, for example, a motor, a piezoelectric element, or an electric stimulator.

The camera module 2380 may capture a still image or moving images. According to an embodiment, the camera module 2380 may include one or more lenses, image sensors, image signal processors, or flashes.

The power management module 2388 may manage power supplied to the electronic device 2301. According to an embodiment, the power management module 2388 may be implemented as at least part of, for example, a power management integrated circuit (PMIC).

The battery 2389 may supply power to at least one component of the electronic device 2301. According to an embodiment, the battery 2389 may include, for example, a primary cell which is not rechargeable, a secondary cell which is rechargeable, or a fuel cell.

The communication module 2390 may support establishing a direct (e.g., wired) communication channel or a wireless communication channel between the electronic device 2301 and the external electronic device (e.g., the electronic device 2302, the electronic device 2304, or the server 2308) and performing communication via the established communication channel. The communication module 2390 may include one or more communication processors that are operable independently from the processor 2320 (e.g., the application processor (AP)) and supports a direct (e.g., wired) communication or a wireless communication. According to an embodiment, the communication module 2390 may include a wireless communication module 2392 (e.g., a cellular communication module, a short-range wireless communication module, or a global navigation satellite system (GNSS) communication module) or a wired communication module 2394 (e.g., a local area network (LAN) communication module or a power line communication (PLC) module). A corresponding one of these communication modules may communicate with the external electronic device via the first network 2398 (e.g., a short-range communication network, such as Bluetooth™, wireless-fidelity (Wi-Fi) direct, or infrared data association (IrDA)) or the second network 2399 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 2392 may identify and authenticate the electronic device 2301 in a communication network, such as the first network 2398 or the second network 2399, using subscriber information (e.g., international mobile subscriber identity (IMSI)) stored in the subscriber identification module 2396.

The wireless communication module 2392 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 2392 may support a high-frequency band (e.g., the millimeter-wave (mmWave) band) to achieve, e.g., a high data transmission rate. The wireless communication module 2392 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 2392 may support various requirements specified in the electronic device 2301, an external electronic device (e.g., the electronic device 2304), or a network system (e.g., the second network 2399). According to an embodiment, the wireless communication module 2392 may support a peak data rate (e.g., 20Gbps or more) for implementing eMBB, loss coverage (e.g., 2364dB or less) for implementing mMTC, or user plane (U-plane) latency (e.g., 0.5ms or less for each of downlink (DL) and uplink (UL), or a round trip of 23ms or less) for implementing URLLC.

The antenna module 2397 may transmit or receive a signal or power to or from the outside (e.g., the external electronic device) of the electronic device 2301. According to an embodiment, the antenna module 2397 may include an antenna including a radiating element composed of a conductive material or a conductive pattern formed in or on a substrate (e.g., a printed circuit board (PCB)). According to an embodiment, the antenna module 2397 may include a plurality of antennas (e.g., array antennas). In such a case, at least one antenna appropriate for a communication scheme used in the communication network, such as the first network 2398 or the second network 2399, may be selected, for example, by the communication module 2390 (e.g., the wireless communication module 2392) from the plurality of antennas. The signal or the power may then be transmitted or received between the communication module 2390 and the external electronic device via the selected at least one antenna. According to an embodiment, another component (e.g., a radio frequency integrated circuit (RFIC)) other than the radiating element may be additionally formed as part of the antenna module 2397.

According to various embodiments, the antenna module 2397 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 2301 and the external electronic device 2304 via the server 2308 coupled with the second network 2399. Each of the electronic devices 2302 or 2304 may be a device of a same type as, or a different type, from the electronic device 2301. According to an embodiment, all or some of operations to be executed at the electronic device 2301 may be executed at one or more of the external electronic devices 2302, 2304, or 2308. For example, if the electronic device 2301 should perform a function or a service automatically, or in response to a request from a user or another device, the electronic device 2301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 2301. The electronic device 2301 may provide the outcome, with or without further processing of the outcome, as at least part of a reply to the request. To that end, a cloud computing, distributed computing, mobile edge computing (MEC), or client-server computing technology may be used, for example. The electronic device 2301 may provide ultra low-latency services using, e.g., distributed computing or mobile edge computing. In another embodiment, the external electronic device 2304 may include an internet-of-things (IoT) device. The server 2308 may be an intelligent server using machine learning and/or a neural network. According to an embodiment, the external electronic device 2304 or the server 2308 may be included in the second network 2399. The electronic device 2301 may be applied to intelligent services (e.g., smart home, smart city, smart car, or healthcare) based on 5G communication technology or IoT-related technology.

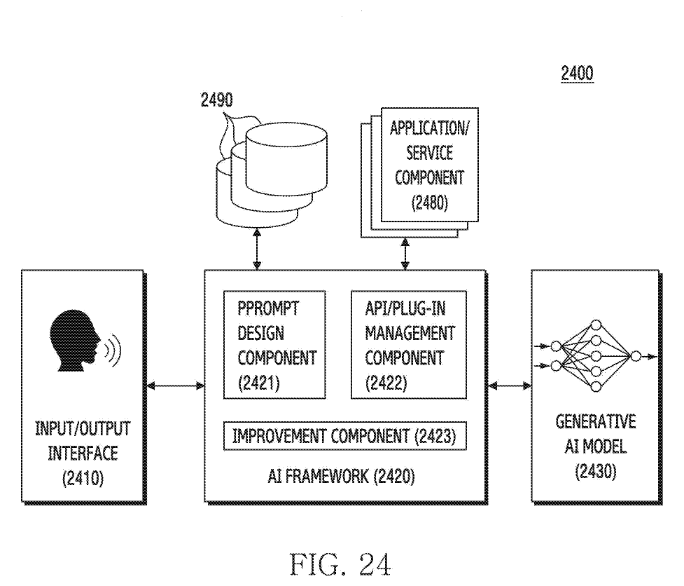

A portion of the operations described above may be executed (or performed) through an artificial intelligence (AI) system described with reference to FIG. 24.

FIG. 24 is a schematic diagram of an exemplary AI system.

Referring to FIG. 24, an AI system 2400 may include an input/output interface 2410, an artificial intelligence (AI) framework 2420, a generative AI model 2430, and/or a knowledge storage 2490.

The input/output interface 2410 may receive an input. The input may include a user input and/or data obtained or generated by an electronic device (e.g., the above-described electronic device 100 or the electronic device 2301). The data may include an image, a video, and/or sensor data (e.g., illuminance data of surroundings of the electronic device obtained from a sensor or a sensor hub (e.g., the auxiliary processor 2323), posture data (or orientation data) of the electronic device, an internal temperature of the electronic device (e.g., a temperature of the display 208 or a temperature of the at least one processor 210), size information of a display area of the display 208, and/or an image obtained through an image sensor (e.g., included in the camera module 2380) of the electronic device) generated by at least one processor (e.g., the at least one processor 210 or the processor 2320) of the electronic device. The user input may include a natural language, touch data obtained through touch circuitry included in the display panel (e.g., used to identify an input from a finger and/or a stylus), an image displayed (and/or to be displayed) on the display panel, and/or a video. As a non-limiting example, the user input may be received by the input/output interface 2410 together with context information. The context information may be described as additional information obtained in relation to the user input. The context information may be related to a state when the user input is received (e.g., including a state of the electronic device and/or a state around the electronic device (e.g., a user state)). For example, the context information may include information about one or more software applications executed in the electronic device when the user input is received. For example, the context information may include information about a position of the electronic device (or a position of a user of the electronic device) when the user input is received. For example, the user input may be integrated with the context information. For example, as the user input, the user input integrated with the context information may be received by the input/output interface 2410.

The input/output interface 2410 may transmit (or provide) an output. The output may include a result (or result information) generated or obtained by the AI system 2400 based at least in part on the input. A format of the output may vary. For example, the output may include a natural language. For example, the output may include a content (e.g., including media content and/or multimedia content). For example, the output may include an action related to a user of the electronic device. For example, the output may have a format according to user settings of the electronic device.

The input/output interface 2410 may be described as a user query/response interface 2410.

The AI framework 2420 may obtain information (or data) about the input from the input/output interface 2410 and may be used to control one or more components related to the AI system 2400 by using the obtained information.

For example, a prompt design component 2421 in the AI framework 2420 may generate or obtain a prompt for the generative AI model 2430 (e.g., including a large language model (LLM) or a large multimodal model (LMM)) by using the obtained information. For example, the prompt design component 2421 may be described as an AI component that uses a learning algorithm and/or a neural network to provide an enhanced prompt over time. For example, the prompt design component 2421 may generate or obtain a prompt by accessing a knowledge component (e.g., the knowledge storage 2490) including user preference data, a prompt library, and/or a prompt example by using the obtained information. The generated prompt may be provided to the generative AI model 2430 (e.g., including the LLM or the LMM).

For example, an application programming interface (API)/plugin management component 2422 in the AI framework 2420 may be used to support communication for additional information requested (or caused) in relation to the prompt provided (or to be provided) to the generative AI model 2430. For example, the API/plugin management component 2422 may be used to generate or establish a channel for communication with various data sources (e.g., the knowledge storage 2490). For example, the API/plugin management component 2422 may support access to at least a portion of the data sources. For example, the API/plugin management component 2422 may be used to request another component (e.g., an application/service component 2480) that performs feedback (or response) according to the prompt. As a non-limiting example, information obtained (or generated) through the API/plugin management component 2422 may be provided to the prompt design component 2421 for generating a prompt. As a non-limiting example, information obtained (or generated) through the API/plugin management component 2422 may be provided to the generative AI model 2430.

For example, an improvement component 2423 in the AI framework 2420 may at least partially tune (or adjust) (or modify) a result (e.g., content) obtained (or outputted) from the generative AI model 2430. For example, the improvement component 2423 may determine or verify whether a content obtained from the generative AI model 2430 is related to the input. For example, the improvement component 2423 may determine or verify whether a content obtained from the generative AI model 2430 includes biased information. For example, the improvement component 2423 may determine or verify whether a content obtained from the generative AI model 2430 includes harmful content. For example, the improvement component 2423 may support or assist in performing an additional processing to improve a content obtained from the generative AI model 2430. For example, the improvement component 2423 may support providing a hint to a user to improve the content.

The generative AI model 2430 may be described as an artificial intelligence neural network that generates feedback, in response to a prompt. For example, the feedback may be related to the prompt, but may further include additional data and/or information relative to the prompt. For example, the feedback may include a new content relative to the prompt. For example, the generative AI model 2430 may include a model generating an image and/or a model generating a language. For example, the model generating an image may include a generative adversarial network (GAN) and/or a variational auto encoder (VAE). For example, the model generating an image may include a diffusion-based generative model (e.g., a transformer VAE). For example, the model generating a language may include CHAT-GPT 3 and/or CHAT-GPT 4. For example, the generative AI model 2430 may include an LMM generating the feedback by recognizing text, an image, and/or a voice.

As a non-limiting example, the AI framework 2420 and/or the generative AI model 2430 may be included in an AI module (e.g., including processing circuitry) in the electronic device. For example, the AI module may be operably coupled with at least one processor (e.g., the at least one processor 210 or the processor 2320) of the electronic device. For example, the AI module may be operably coupled with display driver circuitry (e.g., the display driver circuitry or the display driver IC (DDI)) of the electronic device. For example, the AI module may be operably coupled with a sensor hub of the electronic device for one or more sensors in the electronic device.

The technical problems to be achieved in this document are not limited to those described above, and other technical problems not mentioned herein will be clearly understood by those having ordinary knowledge in the art to which the disclosure belongs, from the following description.

An electronic device (e.g., the electronic device 100) as described above may include memory (e.g., the memory 206) storing instructions. The electronic device may include a display (e.g., the display 208). The electronic device may include at least one processor (e.g., the at least one processor 210). The instructions, when executed by the at least one processor individually or collectively, may cause the electronic device to display, via the display, a screen including a widget (e.g., the widget 412) corresponding to a software application. The instructions, when executed by the at least one processor individually or collectively, may cause the electronic device to identify whether a condition for suggesting execution of a preset function provided through the software application is satisfied while the widget is included in the screen. The instructions, when executed by the at least one processor individually or collectively, may cause the electronic device to display, via the display, the screen including a stacked element (e.g., the stacked element 425), which is displayed superimposed on the widget and suggests executing the preset function, based on determination that the condition is satisfied.

According to an embodiment of the disclosure, the screen may be a first screen. The instructions, when executed by the at least one processor individually or collectively, may cause the electronic device to receive a tap input for the stacked element while displaying the stacked element displayed superimposed on the widget via the display. The instructions, when executed by the at least one processor individually or collectively, may cause the electronic device to switch a screen displayed via the display from the first screen to a second screen for executing the preset function based on receiving the tap input.

According to an embodiment of the disclosure, the instructions, when executed by the at least one processor individually or collectively, may cause the electronic device to, after displaying the second screen via the display, based on receiving a user input to display the first screen, display, via the display, the first screen including the widget without displaying the stacked element superimposed on the widget.

According to an embodiment of the disclosure, the instructions, when executed by the at least one processor individually or collectively, may cause the electronic device to receive a swipe input for the stacked element while displaying the stacked element displayed superimposed on the widget via the display. The instructions, when executed by the at least one processor individually or collectively, may cause the electronic device to display the widget, among the widget and the stacked element, on the screen, based on receiving the swipe input.

According to an embodiment of the disclosure, the instructions, when executed by the at least one processor individually or collectively, may cause the electronic device to identify a size of the widget before displaying the stacked element displayed superimposed on the widget via the display. The instructions, when executed by the at least one processor individually or collectively, may cause the electronic device to identify a size of the widget before displaying the stacked element displayed superimposed on the widget via the display. The instructions, when executed by the at least one processor individually or collectively, may cause the electronic device to display, via the display, the stacked element displayed superimposed on the widget based on determination that the size of the widget is smaller than a threshold size. The instructions, when executed by the at least one processor individually or collectively, may cause the electronic device to display, on the widget, a visual object corresponding to the stacked element and suggesting execution of the preset function, based on determination that the size of the widget is larger than the threshold size.

According to an embodiment of the disclosure, the instructions, when executed by the at least one processor individually or collectively, may cause the electronic device to receive a first user input for the stacked element while displaying the stacked element superimposed on the widget. The instructions, when executed by the at least one processor individually or collectively, may cause the electronic device to display, via the display, a user interface (UI) object for controlling the stacked element, based on receiving the first user input. The instructions, when executed by the at least one processor individually or collectively, may cause the electronic device to display the widget on the screen without displaying the stacked element superimposed on the widget based on receiving a second user input with respect to the UI object.

According to an embodiment of the disclosure, the stacked element may include at least a portion of result information obtained based on the preset function executed through the electronic device.

According to an embodiment of the disclosure, the stacked element may include a graphical object indicating that the preset function is provided through a pre-trained model.

According to an embodiment of the disclosure, the stacked element may include a visual indication indicating that the widget or another stacked element is disposed under the stacked element.

According to an embodiment of the disclosure, a portion of the stacked element may include a filter that performs blur processing on a portion of the widget disposed under the stacked element.

According to an embodiment of the disclosure, the stacked element may include another UI object for controlling providing the preset function based on a user input received through the stacked element.

According to an embodiment of the disclosure, the preset function may be provided through an artificial intelligence model.

As described above, a method performed by an electronic device (e.g., the electronic device 100) with a display (e.g., the display 208) may include displaying, via the display, a screen including a widget (e.g., the widget 412) corresponding to a software application. The method may include identifying whether a condition for suggesting execution of a preset function provided through the software application is satisfied while the widget is included in the screen. The method may include displaying, via the display, the screen including a stacked element (e.g., the stacked element 425), which is displayed superimposed on the widget and suggests execution of the preset function, based on determination that the condition is satisfied.

According to an embodiment of the disclosure, the screen may be a first screen. The method may include receiving a tap input with respect to the stacked element while displaying the stacked element displayed superimposed on the widget via the display. The method may include switching a screen displayed via the display from the first screen to a second screen for executing the preset function based on receiving the tab input.

According to an embodiment of the disclosure, the method may include, after displaying the second screen via the display, based on receiving a user input to display the first screen, displaying, via the display, the first screen including the widget without displaying the stacked element superimposed on the widget.

According to an embodiment of the disclosure, the method may include receiving a swipe input for the stacked element while displaying the stacked element displayed superimposed on the widget via the display. The method may include displaying, on the screen, the widget among the widget and the stacked element based on receiving the swipe input.

According to an embodiment of the disclosure, the method may include identifying a size of the widget before displaying the stacked element displayed superimposed on the widget via the display. The method may include displaying, via the display, the stacked element displayed superimposed on the widget based on determination that the size of the widget is smaller than a threshold size. The method may include displaying, on the widget, a visual object corresponding to the stacked element and suggesting execution of the preset function based on determination that the size of the widget is larger than the threshold size.

According to an embodiment of the disclosure, the method may include receiving a first user input for the stacked element while displaying the stacked element superimposed on the widget. The method may include displaying, via the display, a user interface (UI) object for controlling the stacked element based on receiving the first user input. The method may include displaying the widget on the screen without displaying the stacked element superimposed on the widget based on receiving a second user input for the UI object.

According to an embodiment of the disclosure, the stacked element may include at least a portion of result information obtained based on the preset function executed through the electronic device.

According to an embodiment of the disclosure, the stacked element may include a graphical object indicating that the preset function is provided through a pre-trained model.

According to an embodiment of the disclosure, the stacked element may include a visual indication indicating that the widget or another stacked element is disposed under the stacked element.

According to an embodiment of the disclosure, a portion of the stacked element may include a filter that performs blur processing on a portion of the widget disposed under the stacked element.

According to an embodiment of the disclosure, the stacked element may include another UI object for controlling providing the preset function based on a user input received through the stacked element.

According to an embodiment of the disclosure, the preset function may be provided through an artificial intelligence model.

As described above, in a computer readable storage medium storing one or more programs, the one or more programs may include, when executed by an electronic device (e.g., the electronic device 100) with a display (e.g., the display 208), instructions causing the electronic device to display, via the display, a screen including a widget (e.g., the widget 412) corresponding to a software application. The one or more programs may include, when executed by the electronic device, instructions causing the electronic device to identify whether a condition for suggesting execution of a preset function provided through the software application is satisfied while the widget is included in the screen. The one or more programs may include, when executed by the electronic device, instructions causing the electronic device to display, via the display, the screen including a stacked element, which is displayed superimposed on the widget and suggests execution of the preset function, based on determination that the condition is satisfied.

According to an embodiment of the disclosure, the screen may be a first screen. The one or more programs may include, when executed by the electronic device, instructions causing the electronic device to receive a tap input for the stacked element while displaying the stacked element displayed superimposed on the widget via the display. The one or more programs may include, when executed by the electronic device, instructions causing the electronic device to switch a screen displayed via the display from the first screen to a second screen for executing the preset function based on receiving the tap input.

According to an embodiment of the disclosure, the screen may be the first screen. The one or more programs may include, when executed by the electronic device, instructions causing the electronic device to, after displaying the second screen via the display, based on receiving a user input to display the first screen, display, via the display, the first screen including the widget without displaying the stacked element superimposed on the widget.

According to an embodiment of the disclosure, the one or more programs may include, when executed by the electronic device, instructions causing the electronic device to receive a swipe input for the stacked element while displaying the stacked element displayed superimposed on the widget via the display. The one or more programs may include, when executed by the electronic device, instructions causing the electronic device to display the widget, among the widget and the stacked element, on the screen, based on receiving the swipe input.

According to an embodiment of the disclosure, the one or more programs may include, when executed by the electronic device, instructions causing the electronic device to identify a size of the widget before displaying the stacked element displayed superimposed on the widget via the display. The one or more programs may include, when executed by the electronic device, instructions causing the electronic device to display, via the display, the stacked element displayed superimposed on the widget based on determination that the size of the widget is smaller than a threshold size. The one or more programs may include, when executed by the electronic device, instructions causing the electronic device to display, on the widget, a visual object corresponding to the stacked element and suggesting execution of the preset function, based on determination that the size of the widget is larger than the threshold size.

According to an embodiment of the disclosure, the one or more programs may include, when executed by the electronic device, instructions causing the electronic device to receive a first user input for the stacked element while displaying the stacked element superimposed on the widget. The one or more programs may include, when executed by the electronic device, instructions causing the electronic device to display, via the display, a user interface (UI) object for controlling the stacked element, based on receiving the first user input. The one or more programs may include, when executed by the electronic device, instructions causing the electronic device to display the widget on the screen without displaying the stacked element superimposed on the widget based on receiving a second user input with respect to the UI object.

According to an embodiment of the disclosure, the stacked element may include at least a portion of result information obtained based on the preset function executed through the electronic device.

According to an embodiment of the disclosure, the stacked element may include a graphical object indicating that the preset function is provided through a pre-trained model.

According to an embodiment of the disclosure, the stacked element may include a visual indication indicating that the widget or another stacked element is disposed under the stacked element.

According to an embodiment of the disclosure, a portion of the stacked element may include a filter that performs blur processing on a portion of the widget disposed under the stacked element.

According to an embodiment of the disclosure, the stacked element may include another UI object for controlling providing the preset function based on a user input received through the stacked element.

According to an embodiment of the disclosure, the preset function may be provided through an artificial intelligence model.

An electronic device (e.g., the electronic device 100) as described above may include memory (e.g., the memory 206) storing instructions. The electronic device may include a display (e.g., the display 208). The electronic device may include at least one processor (e.g., the at least one processor 210). The instructions, when executed by the at least one processor individually or collectively, may cause the electronic device to identify whether a condition for generating a widget providing a defined feature is satisfied. The instructions, when executed by the at least one processor individually or collectively, may cause the electronic device to display a bar-shaped widget on a home screen indicating that the condition is satisfied, based on determination that the condition is satisfied. The instructions, when executed by the at least one processor individually or collectively, may cause the electronic device to display, via the display, a pop-up window suggesting generation of the widget, based on receiving a first user input for the bar-shaped widget. The instructions, when executed by the at least one processor individually or collectively, may cause the electronic device to display the widget providing the defined feature on the home screen, based on receiving a second user input for the pop-up window.

According to an embodiment of the disclosure, the home screen may include a main area for changing a UI object displayed via the display dependently on a user input, and an icon tray area for displaying a UI object independently of the user input. The bar-shaped widget may be displayed between the main area and the icon tray area.

According to an embodiment of the disclosure, the instructions, when executed by the at least one processor individually or collectively, may cause the electronic device to receive a swipe input for the home screen while displaying the bar-shaped widget on the home screen. The instructions, when executed by the at least one processor individually or collectively, may cause the electronic device to display, on the home screen, a visual indication indicating that another home screen may be displayed by ceasing displaying the bar-shaped widget based on receiving the swipe input.

According to an embodiment of the disclosure, the instructions, when executed by the at least one processor individually or collectively, may cause the electronic device to display the pop-up window via the display when executing a software application for providing the defined feature based on determination that the condition is satisfied.

According to an embodiment of the disclosure, the condition may include that the number of times a software application providing the defined feature is executed based on a user input received in the home screen exceeds a threshold number of times.

According to an embodiment of the disclosure, the condition may include that the number of times the defined feature is provided exceeds a threshold number of times.

As described above, a method performed by an electronic device (e.g., the electronic device 100) with a display (e.g., the display 208) may include identifying whether a condition for generating a widget providing a defined feature is satisfied. The method may include displaying a bar-shaped widget on a home screen indicating that the condition is satisfied, based on determination that the condition is satisfied. The method may include displaying, via the display, a pop-up window suggesting generation of the widget, based on receiving a first user input for the bar-shaped widget. The method may include displaying the widget providing the defined feature on the home screen, based on receiving a second user input for the pop-up window.

According to an embodiment of the disclosure, the home screen may include a main area for changing a UI object displayed via the display dependently on a user input, and an icon tray area for displaying a UI object independently of the user input. The bar-shaped widget may be displayed between the main area and the icon tray area.

According to an embodiment of the disclosure, the method may include receiving a swipe input for the home screen while displaying the bar-shaped widget on the home screen. The method may include displaying, on the home screen, a visual indication indicating that another home screen may be displayed by ceasing displaying the bar-shaped widget based on receiving the swipe input.

According to an embodiment of the disclosure, the method may include displaying the pop-up window via the display when executing a software application for providing the defined feature based on determination that the condition is satisfied.

According to an embodiment of the disclosure, the condition may include that the number of times a software application providing the defined feature is executed based on a user input received in the home screen exceeds a threshold number of times.

According to an embodiment of the disclosure, the condition may include that the number of times the defined feature is provided exceeds a threshold number of times.

As described above, in a computer readable storage medium storing one or more programs, the one or more programs may include, when executed by an electronic device (e.g., the electronic device 100) with a display (e.g., the display 208), instructions causing the electronic device to identify whether a condition for generating a widget providing a defined feature is satisfied. The one or more programs may include, when executed by the electronic device, instructions causing the electronic device to display a bar-shaped widget on a home screen indicating that the condition is satisfied, based on determination that the condition is satisfied. The one or more programs may include, when executed by the electronic device, instructions causing the electronic device to display, via the display, a pop-up window suggesting generation of the widget, based on receiving a first user input for the bar-shaped widget. The one or more programs may include, when executed by the electronic device, instructions causing the electronic device to display the widget providing the defined feature on the home screen, based on receiving a second user input for the pop-up window.

According to an embodiment of the disclosure, the home screen may include a main area for changing a UI object displayed via the display dependently on a user input, and an icon tray area for displaying a UI object independently of the user input. The bar-shaped widget may be displayed between the main area and the icon tray area.

According to an embodiment of the disclosure, the one or more programs may include, when executed by the electronic device, instructions causing the electronic device to receive a swipe input for the home screen while displaying the bar-shaped widget on the home screen. The one or more programs may include, when executed by the electronic device, instructions causing the electronic device to display, on the home screen, a visual indication indicating that another home screen may be displayed by ceasing displaying the bar-shaped widget based on receiving the swipe input.

According to an embodiment of the disclosure, the one or more programs may include, when executed by the electronic device, instructions causing the electronic device to display the pop-up window via the display when executing a software application for providing the defined feature based on determination that the condition is satisfied.

According to an embodiment of the disclosure, the condition may include that the number of times a software application providing the defined feature is executed based on a user input received in the home screen exceeds a threshold number of times.

According to an embodiment of the disclosure, the condition may include that the number of times the defined feature is provided exceeds a threshold number of times.

An electronic device (e.g., the electronic device 100) as described above may include memory (e.g., the memory 206) storing instructions. The electronic device may include a display (e.g., the display 208). The electronic device may include at least one processor (e.g., the at least one processor 210). The instructions, when executed by the at least one processor individually or collectively, may cause the electronic device to display, via the display, a screen including a widget corresponding to a software application. The instructions, when executed by the at least one processor individually or collectively, may cause the electronic device to identify at least one executable action in relation with the software application. The instructions, when executed by the at least one processor individually or collectively, may cause the electronic device to display, via the display, a stacked element at least partially superimposed on the widget to suggest the at least one executable action.

According to an embodiment of the disclosure, the screen may include a first screen and a second screen. The instructions, when executed by the at least one processor individually or collectively, may cause the electronic device to receive a first user input with respect to the stacked element. The instructions, when executed by the at least one processor individually or collectively, may cause the electronic device to, in response to the first user input, display a second screen to execute the at least one executable action via the display.

According to an embodiment of the disclosure, the instructions, when executed by the at least one processor individually or collectively, may cause the electronic device to, after displaying the second screen via the display, receive a second user input to display the first screen, via the display. The instructions, when executed by the at least one processor individually or collectively, may cause the electronic device to, in response to the second user input, display, via the display, the first screen including the widget without the stacked element.

According to an embodiment of the disclosure, the instructions, when executed by the at least one processor individually or collectively, may cause the electronic device to receive a third user input for the stacked element. The instructions, when executed by the at least one processor individually or collectively, may cause the electronic device to, in response to the third user input, refrain from displaying the stacked element on the widget.

According to an embodiment of the disclosure, the instructions, when executed by the at least one processor individually or collectively, may cause the electronic device to, as at least a portion of the identification, identify a size of the widget. The instructions, when executed by the at least one processor individually or collectively, may cause the electronic device to, based at least in part on determination that a size of the widget corresponds to a first size, display, via the display, the stacked element superimposed on the widget. The instructions, when executed by the at least one processor individually or collectively, may cause the electronic device to, based at least in part on determination that a size of the widget corresponds to a second size larger than the first size, display, via the display, a graphical object indicating the at least one executable action with the stacked element on the widget.

According to an embodiment of the disclosure, the instructions, when executed by the at least one processor individually or collectively, may cause the electronic device to receive a fourth user input for the stacked element. The instructions, when executed by the at least one processor individually or collectively, may cause the electronic device to, in response to the fourth user input, display, via the display, a user interface (UI) object for controlling the stacked element. The instructions, when executed by the at least one processor individually or collectively, may cause the electronic device to, in response to receiving a fifth user input with respect to the UI object, refrain from displaying the stacked element on the widget.

According to an embodiment of the disclosure, the stacked element may include at least a portion of result information corresponding to the at least one executable action.

According to an embodiment of the disclosure, the stacked element may include another graphical object indicating that the at least one executable action is provided via a machine learning model.

According to an embodiment of the disclosure, the stacked element may include a visual indicator indicating another widget or another stacked element.

According to an embodiment of the disclosure, the stacked element may include at least a partially blurred portion with respect to a portion of the widget.

According to an embodiment of the disclosure, the stacked element may include another UI object to control the at least one executable action.

According to an embodiment of the disclosure, the at least one executable action may be provided via a machine learning model trained to provide at least one executable action using information corresponding to a software application.

As described above, a method performed by an electronic device (e.g., the electronic device 100) with a display (e.g., the display 208) may include displaying, via the display, a screen including a widget corresponding to a software application. The method may include identifying at least one executable action in relation with the software application. The method may include displaying, via the display, a stacked element at least partially superimposed on the widget to suggest the at least one executable action.

According to an embodiment of the disclosure, the screen may include a first screen and a second screen. The method may include receiving a first user input with respect to the stacked element. The method may include, in response to the first user input, displaying a second screen to execute the at least one executable action via the display.

According to an embodiment of the disclosure, the method may include, after displaying the second screen via the display, receiving a second user input to display the first screen, via the display. The method may include, in response to the second user input, displaying, via the display, the first screen including the widget without the stacked element.

According to an embodiment of the disclosure, the method may include receiving a third user input for the stacked element. The method may include, in response to the third user input, refraining from displaying the stacked element on the widget.

According to an embodiment of the disclosure, the method may include, as at least a portion of the identification, identifying a size of the widget. The method may include, based at least in part on determination that a size of the widget corresponds to a first size, displaying, via the display, the stacked element superimposed on the widget. The method may include, based at least in part on determination that a size of the widget corresponds to a second size larger than the first size, displaying, via the display, a graphical object indicating the at least one executable action with the stacked element on the widget.

According to an embodiment of the disclosure, the method may include receiving a fourth user input with respect to the stacked element. The method may include, in response to the fourth user input, displaying, via the display, a user interface (UI) object for controlling the stacked element. The method may include, in response to receiving a fifth user input with respect to the UI object, refraining from displaying the stacked element on the widget.

According to an embodiment of the disclosure, the stacked element may include at least a portion of result information corresponding to the at least one executable action.

According to an embodiment of the disclosure, the stacked element may include another graphical object indicating that the at least one executable action is provided via a machine learning model.

According to an embodiment of the disclosure, the stacked element may include a visual indicator indicating another widget or another stacked element.

According to an embodiment of the disclosure, the stacked element may include at least a partially blurred portion with respect to a portion of the widget.

According to an embodiment of the disclosure, the stacked element may include another UI object to control the at least one executable action.

According to an embodiment of the disclosure, the at least one executable action may be provided via a machine learning model trained to provide at least one executable action using information corresponding to a software application.

As described above, in a computer readable storage medium storing one or more programs, the one or more programs may include, when executed by an electronic device (e.g., the electronic device 100) with a display (e.g., the display 208), instructions causing the electronic device to display, via the display, a screen including a widget corresponding to a software application. The one or more programs may include, when executed by the electronic device, instructions causing the electronic device to identify at least one executable action in relation with the software application. The one or more programs may include, when executed by the electronic device, instructions causing the electronic device to display, via the display, a stacked element at least partially superimposed on the widget to suggest the at least one executable action.

According to an embodiment of the disclosure, the screen may include a first screen and a second screen. The one or more programs may include, when executed by the electronic device, instructions causing the electronic device to receive a first user input with respect to the stacked element. The one or more programs may include, when executed by the electronic device, instructions causing the electronic device to, in response to the first user input, display a second screen to execute the at least one executable action via the display.

According to an embodiment of the disclosure, the one or more programs may include, when executed by the electronic device, instructions causing the electronic device to, after displaying the second screen via the display, receive a second user input to display the first screen, via the display. The one or more programs may include, when executed by the electronic device, instructions causing the electronic device to, in response to the second user input, display, via the display, the first screen including the widget without the stacked element.

According to an embodiment of the disclosure, the one or more programs may include, when executed by the electronic device, instructions causing the electronic device to receive a third user input for the stacked element. The one or more programs may include, when executed by the electronic device, instructions causing the electronic device to, in response to the third user input, refrain from displaying the stacked element on the widget.

According to an embodiment of the disclosure, the one or more programs may include, when executed by the electronic device, instructions causing the electronic device to, as at least a portion of the identification, identify a size of the widget. The one or more programs may include, when executed by the electronic device, instructions causing the electronic device to, based at least in part on determination that a size of the widget corresponds to a first size, display, via the display, the stacked element superimposed on the widget. The one or more programs may include, when executed by the electronic device, instructions causing the electronic device to, based at least in part on determination that a size of the widget corresponds to a second size larger than the first size, display, via the display, a graphical object indicating the at least one executable action with the stacked element on the widget.

According to an embodiment of the disclosure, the one or more programs may include, when executed by the electronic device, instructions causing the electronic device to receive a fourth user input for the stacked element. The one or more programs may include, when executed by the electronic device, instructions causing the electronic device to, in response to the fourth user input, display, via the display, a user interface (UI) object for controlling the stacked element. The one or more programs may include, when executed by the electronic device, instructions causing the electronic device to, in response to receiving a fifth user input with respect to the UI object, refrain from displaying the stacked element on the widget.

According to an embodiment of the disclosure, the stacked element may include at least a portion of result information corresponding to the at least one executable action.

According to an embodiment of the disclosure, the stacked element may include another graphical object indicating that the at least one executable action is provided via a machine learning model.

According to an embodiment of the disclosure, the stacked element may include a visual indicator indicating another widget or another stacked element.

According to an embodiment of the disclosure, the stacked element may include at least a partially blurred portion with respect to a portion of the widget.

According to an embodiment of the disclosure, the stacked element may include another UI object to control the at least one executable action.

According to an embodiment of the disclosure, the at least one executable action may be provided via a machine learning model trained to provide at least one executable action using information corresponding to a software application.

An electronic device (e.g., the electronic device 100) as described above may include memory (e.g., the memory 206) storing instructions. The electronic device may include a display (e.g., the display 208). The electronic device may include at least one processor (e.g., the at least one processor 210). The instructions, when executed by the at least one processor individually or collectively, may cause the electronic device to identify at least one executable action in relation with a software application. The instructions, when executed by the at least one processor individually or collectively, may cause the electronic device to, based at least in part on the identification, display, via the display, a graphical object indicating the at least one executable action on a home screen. The instructions, when executed by the at least one processor individually or collectively, may cause the electronic device to receive, via the display, a first user input with respect to the graphical object. The instructions, when executed by the at least one processor individually or collectively, may cause the electronic device to display, via the display, a pop-up window to generate a widget corresponding to the at least one executable action. The instructions, when executed by the at least one processor individually or collectively, may cause the electronic device to receive, via the display, a second user input with respect to the pop-up window. The instructions, when executed by the at least one processor individually or collectively, may cause the electronic device to display, via the display, the widget on the home screen.

According to an embodiment of the disclosure, the home screen may include a first area in which the widget is displayable, and a second area in which the widget is not displayable. The graphical object may be displayed between the first area and the second area.

According to an embodiment of the disclosure, the instructions, when executed by the at least one processor individually or collectively, may cause the electronic device to receive a swipe input with respect to the graphical object. The instructions, when executed by the at least one processor individually or collectively, may cause the electronic device to, in response to the swipe input, refrain from displaying the graphical object. The instructions, when executed by the at least one processor individually or collectively, may cause the electronic device to display, via the display, a visual indication in a location where the graphical object is displayed. The visual indication may indicate that another home screen is capable of being displayed.

According to an embodiment of the disclosure, the instructions, when executed by the at least one processor individually or collectively, may cause the electronic device to perform displaying of the pop-up window when executing the software application.

According to an embodiment of the disclosure, the instructions, when executed by the at least one processor individually or collectively, may cause the electronic device to, based at least in part on determination that the software application is executed more than a specified number of times, perform identifying the at least one executable action.

According to an embodiment of the disclosure, the instructions, when executed by the at least one processor individually or collectively, may cause the electronic device to, based at least in part on determination that a feature of the software application is executed more than another specified number of times, perform identifying the at least one executable action.

As described above, a method performed by an electronic device (e.g., the electronic device 100) with a display (e.g., the display 208) may include identifying at least one executable action in relation with a software application. The method may include, based at least in part on the identification, displaying, via the display, a graphical object indicating the at least one executable action on a home screen. The method may include receiving, via the display, a first user input with respect to the graphical object. The method may include displaying, via the display, a pop-up window to generate a widget corresponding to the at least one executable action. The method may include receiving, via the display, a second user input with respect to the pop-up window. The method may include displaying, via the display, the widget on the home screen.

According to an embodiment of the disclosure, the home screen may include a first area in which the widget is displayable, and a second area in which the widget is not displayable. The graphical object may be displayed between the first area and the second area.

According to an embodiment of the disclosure, the method may include receiving a swipe input with respect to the graphical object. The method may include, in response to the swipe input, refraining from displaying the graphical object. The method may include displaying, via the display, a visual indication in a location where the graphical object is displayed. The visual indication may indicate that another home screen is capable of being displayed.

According to an embodiment of the disclosure, the method may include refraining from performing displaying the pop-up window when executing the software application.

According to an embodiment of the disclosure, the method may include, based at least in part on determination that the software application is executed more than a specified number of times, performing identifying the at least one executable action.

According to an embodiment of the disclosure, the method may include, based at least in part on determination that a feature of the software application is executed more than another specified number of times, performing identifying the at least one executable action.

As described above, in a computer readable storage medium storing one or more programs, the one or more programs may include, when executed by an electronic device (e.g., the electronic device 100) with a display (e.g., the display 208), instructions causing the electronic device to identify at least one executable action in relation with a software application. The one or more programs may include, when executed by the electronic device, instructions causing the electronic device to display, based at least in part on the identification, via the display, a graphical object indicating the at least one executable action on a home screen. The one or more programs may include, when executed by the electronic device, instructions causing the electronic device to receive, via the display, a first user input with respect to the graphical object. The one or more programs may include, when executed by the electronic device, instructions causing the electronic device to display, via the display, a pop-up window to generate a widget corresponding to the at least one executable action. The one or more programs may include, when executed by the electronic device, instructions causing the electronic device to receive, via the display, a second user input with respect to the pop-up window. The one or more programs may include, when executed by the electronic device, instructions causing the electronic device to display, via the display, the widget on the home screen.

According to an embodiment of the disclosure, the home screen may include a first area in which the widget is displayable, and a second area in which the widget is not displayable. The graphical object may be displayed between the first area and the second area.

According to an embodiment of the disclosure, the one or more programs may include, when executed by the electronic device, instructions causing the electronic device to receive a swipe input with respect to the graphical object. The one or more programs may include, when executed by the electronic device, instructions causing the electronic device to, in response to the swipe input, refrain from displaying the graphical object. The one or more programs may include, when executed by the electronic device, instructions causing the electronic device to display, via the display, a visual indication in a location where the graphical object is displayed. The visual indication may indicate that another home screen is capable of being displayed.

According to an embodiment of the disclosure, the one or more programs may include, when executed by the electronic device, instructions causing the electronic device to perform displaying of the pop-up window when executing the software application.

According to an embodiment of the disclosure, the one or more programs may include, when executed by the electronic device, instructions causing the electronic device to, based at least in part on determination that the software application is executed more than a specified number of times, perform identifying the at least one executable action.

According to an embodiment of the disclosure, the one or more programs may include, when executed by the electronic device, instructions causing the electronic device to, based at least in part on determination that a feature of the software application is executed more than another specified number of times, perform identifying the at least one executable action.

The effects that can be obtained from the disclosure are not limited to those described above, and any other effects not mentioned herein will be clearly understood by those having ordinary knowledge in the art to which the disclosure belongs, from the following description.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium, such as hard disk, floppy disk, and magnetic tape, optical recording medium, such as compact disc (CD)-ROM and digital versatile disc (DVD), magneto-optical medium, such as floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later. According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is Claimed is:

1. An electronic device comprising:
a display;
memory comprising one or more storage media storing instructions; and
at least one processor comprising processing circuitry,
wherein the instructions, when executed by the at least one processor individually or collectively, cause the electronic device to:
display, via the display, a screen including a widget corresponding to a software application,
identify at least one executable action in relation with the software application, and
display, via the display, a stacked element at least partially superimposed on the widget to suggest the at least one executable action.

2. The electronic device of claim 1,
wherein the screen includes a first screen and a second screen, and
wherein the instructions, when executed by the at least one processor individually or collectively, cause the electronic device to:
receive a first user input with respect to the stacked element, and
in response to the first user input, display a second screen to execute the at least one executable action via the display.

3. The electronic device of claim 2, wherein the instructions, when executed by the at least one processor individually or collectively, cause the electronic device to:
after displaying the second screen via the display, receive a second user input to display the first screen via the display, and
in response to the second user input, display, via the display, the first screen including the widget without the stacked element.

4. The electronic device of claim 1, wherein the instructions, when executed by the at least one processor individually or collectively, cause the electronic device to:
receive a third user input with respect to the stacked element, and
in response to the third user input, refrain from displaying the stacked element on the widget.

5. The electronic device of claim 1, wherein the instructions, when executed by the at least one processor individually or collectively, cause the electronic device to:
as at least a portion of the identification, identify a size of the widget,
based at least in part on determination that a size of the widget corresponds to a first size, display, via the display, the stacked element superimposed on the widget, and
based at least in part on determination that a size of the widget corresponds to a second size larger than the first size, display, via the display, a graphical object indicating the at least one executable action with the stacked element on the widget.

6. The electronic device of claim 1, wherein the instructions, when executed by the at least one processor individually or collectively, cause the electronic device to:
receive a fourth user input with respect to the stacked element,
in response to the fourth user input, display, via the display, a user interface (UI) object to control the stacked element, and
in response to receiving a fifth user input with respect to the UI object, refrain from displaying the stacked element on the widget.

7. The electronic device of claim 1, wherein the stacked element includes at least a portion of result information corresponding to the at least one executable action.

8. The electronic device of claim 1, wherein the stacked element includes another graphical object indicating that the at least one executable action is provided via a machine learning model.

9. The electronic device of claim 1, wherein the stacked element includes a visual indicator indicating another stacked element or another widget.

10. The electronic device of claim 1, wherein the stacked element includes at least a partially blurred portion with respect to a portion of the widget.

11. The electronic device of claim 1, wherein the stacked element includes another UI object to control the at least one executable action.

12. The electronic device of claim 1, wherein the at least one executable action is provided via a machine learning model trained to provide at least one executable action using information corresponding to a software application.

13. An electronic device comprising:
a display;
memory comprising one or more storage media storing instructions; and
at least one processor comprising processing circuitry,
wherein the instructions, when executed by the at least one processor individually or collectively, cause the electronic device to:
identify at least one executable action in relation with a software application,
based at least in part on the identification, display, via the display, a graphical object indicating the at least one executable action on a home screen,
receive, via the display, a first user input with respect to the graphical object,
display, via the display, a pop-up window to generate a widget corresponding to the at least one executable action,
receive, via the display, a second user input with respect to the pop-up window, and
display, via the display, the widget on the home screen.

14. The electronic device of claim 13,
wherein the home screen includes a first area in which the widget is displayable, and a second area in which the widget is not displayable, and
wherein the graphical object is displayed between the first area and the second area.

15. The electronic device of claim 13, wherein the instructions, when executed by the at least one processor individually or collectively, cause the electronic device to:
receive a swipe input with respect to the graphical object,
in response to the swipe input, refrain from displaying the graphical object, and
display, via the display, a visual indication in a location where the graphical object is displayed, the visual indication indicating that another home screen is capable of being displayed.

16. The electronic device of claim 13, wherein the instructions, when executed by the at least one processor individually or collectively, cause the electronic device to:
perform the displaying of the pop-up window when executing the software application.

17. The electronic device of claim 13, wherein the instructions, when executed by the at least one processor individually or collectively, cause the electronic device to:
based at least in part on determination that the software application is executed more than a specified number of times, perform the identifying of the at least one executable action.

18. The electronic device of claim 13, wherein the instructions, when executed by the at least one processor individually or collectively, cause the electronic device to:
based at least in part on determination that a feature of the software application is executed more than another specified number of times, perform the identifying of the at least one executable action.

19. A method executed in an electronic device with a display, the method comprising:
displaying, via the display, a screen including a widget corresponding to a software application,
identifying at least one executable action in relation with the software application, and
displaying, via the display, a stacked element at least partially superimposed on the widget to suggest the at least one executable action.

20. The method of claim 19,
wherein the screen includes a first screen and a second screen, and
wherein the method comprises:
receiving a first user input with respect to the stacked element, and
in response to the first user input, displaying a second screen to execute the at least one executable action via the display.
